(19) United States
(12) Patent Application Publication
(10) Pub. No.: US 2025/0271322 A1
(43) Pub. Date: Aug. 28, 2025

(54) Correcting HVAC Effect on Pressure Sensor Measurement

(71) Applicant: NextNav, LLC, Santa Clara, CA (US)

(72) Inventors: Michael DORMODY, San Jose, CA (US); Wei LIU, Sunnyvale, CA (US); Badrinath NAGARAJAN, Cupertino, CA (US); Arun RAGHUPATHY, Bangalore (IN)

(73) Assignee: NextNav, LLC, Santa Clara, CA (US)

(21) Appl. No.: 19/043,990

(22) Filed: Feb. 3, 2025

Related U.S. Application Data
(60) Provisional application No. 63/558,255, filed on Feb. 27, 2024.

(51) Int. Cl. G01L 27/00

(52) U.S. Cl. CPC G01L 27/002

(57) ABSTRACT

A location context indicates whether a computing device is in an HVAC environment or a non-HVAC environment. When the computing device is in the HVAC environment, an expected altitude of the computing device is obtained, and a measured altitude of the computing device is determined. An altitude difference is determined between the expected altitude and the measured altitude. The HVAC effect is determined based on the altitude difference. A pressure sensor of the computing device is calibrated based on the HVAC effect, or a corrected measured altitude of the computing device is estimated based on the HVAC effect. In some cases, instead of the altitude difference, the HVAC effect is determined based on a pressure difference.

### RELATED APPLICATIONS

This application claims priority to U.S. Provisional Patent Application No. 63/558,255, filed Feb. 27, 2024, all of which is incorporated herein by reference in its entirety.

### BACKGROUND

Determining the exact 3D location of a device (e.g., typically a mobile device, such as a smartphone or other computing device that is carried and operated by a user) in an environment can be quite challenging, especially when the computing device is located in an urban environment or is located within a building or a moving vehicle. Imprecise estimates of the computing device's altitude, for example, may have life-or-death consequences for the user of the computing device since the imprecise altitude estimate can delay emergency personnel response times as they search for the user on multiple floors of a building. In less dire situations, imprecise altitude estimates can lead a user to the wrong area in an environment.

Environments affected by artificial pressurization, pressure turbulence, and other pressure variations can hinder barometric-based altitude determination. Such environments generally include vehicles and buildings that have HVAC (heating, ventilation, and air-conditioning) capabilities or facilities, though not all such enclosed environments with HVAC necessarily demonstrate significant adverse pressure behavior at all times (e.g., depending on whether vents are closed or open, or air is being actively circulated, among other possible situations). Since barometric-based altitude solutions require an accurate measurement of ambient pressure by a pressure sensor of the device, it is important to flag the data for such environments to alert that the measurement may be affected by HVAC, if detected, so that applications will not use the affected data.

### SUMMARY

In some embodiments, a system or method involves determining a location of a computing device; determining a location context for the computing device, wherein the location context indicates whether the computing device is in an HVAC (heating, ventilating, or air-conditioning) environment that can be subject to an HVAC effect or is in a non-HVAC environment that is not subject to the HVAC effect; upon determining that the computing device is in the non-HVAC environment, not determining the HVAC effect; and upon determining that the computing device is in the HVAC environment: obtaining an expected altitude of the computing device based on the location of the computing device; determining a measured altitude of the computing device based on a reference pressure and a measured pressure from a pressure sensor of the computing device; determining an altitude difference between the expected altitude and the measured altitude; determining the HVAC effect based on the altitude difference; and calibrating the pressure sensor based on the HVAC effect or estimating a corrected measured altitude of the computing device based on the HVAC effect. In some embodiments, a pressure difference is used instead of an altitude difference.

In some embodiments, the determining of the location of the computing device to the determining of the altitude difference is repeated for each time point of a plurality of time points; and the determining of the HVAC effect further includes: for each time point of the plurality of time points, mapping the altitude difference with respect to the location context to generate mapped altitude differences; determining a first cluster of the mapped altitude differences for when the computing device is in the HVAC environment; determining a second cluster of the mapped altitude differences for when the computing device is in the non-HVAC environment; and determining the HVAC effect based on the first cluster of mapped altitude differences and the second cluster of mapped altitude differences. In some embodiments, for each time point of the plurality of time points, the altitude difference is mapped with respect to the time point and the location context to generate the mapped altitude differences. In some embodiments, a magnitude of the HVAC effect is determined that is a difference between a first average of the first cluster of mapped altitude differences and a second average of the second cluster of mapped altitude differences.

In some embodiments, the location context is determined to be in the HVAC environment which is a building. In some embodiments, determining the location context for the computing device further includes: determining that the computing device is in the building by mapping the location of the computing device to a building database, which indicates that the computing device is within the building; determining that the computing device is in the building by determining that the computing device is wirelessly connected to a wireless access point that is known to be in the building, which indicates that the computing device is within the building; or determining that the computing device is in the building by determining that a strength of a satellite signal is attenuated from a level that it should be if the computing device were outdoors, which indicates that the computing device is within the building. In some embodiments, determining the location context for the computing device further includes: determining that the location context is in the HVAC environment which is a vehicle. In some embodiments, determining the location context for the computing device further includes: determining that the computing device is in the vehicle by mapping the location of the computing device to a road database, which indicates that the computing device is on a road and within the vehicle; determining that the computing device is in the vehicle by determining that the computing device is communicatively connected to the vehicle, which indicates that the computing device is within the vehicle; determining that the computing device is in the vehicle by determining that the computing device is moving faster than a walking, running or biking speed, which indicates that the computing device is within the vehicle; determining that the computing device is in the vehicle by determining that the computing device is changing cell tower connections, which indicates that the computing device is within the vehicle; determining that the computing device is in the vehicle by obtaining an activity context from a sensor hub of the computing device that indicates that the activity context is driving, which indicates that the computing device is within the vehicle; or determining that the computing device is in the vehicle by determining that the computing device is in a parking lot, which indicates that the computing device is within the vehicle.

In some embodiments, determining the location context for the computing device further includes: determining a device temperature of the computing device; obtaining a reference temperature based on the location of the computing device; and determining the location context by comparing the device temperature and the reference temperature. In some embodiments, determining the location context for the computing device further includes: determining that the reference temperature and the device temperature are within a threshold temperature range from each other; determining that the reference temperature and the device temperature are both less than a cold threshold temperature; and determining that the computing device is in the non-HVAC environment. In some embodiments, determining the location context for the computing device further includes: determining that the reference temperature and the device temperature are within a threshold temperature range from each other; determining that the reference temperature and the device temperature are both greater than a hot threshold temperature; and determining that the computing device is in the non-HVAC environment. In some embodiments, the location context further indicates whether the computing device is in the HVAC environment, the non-HVAC environment, or an uncertain environment; and determining the location context for the computing device further includes: determining that the reference temperature and the device temperature are within a threshold temperature range from each other; determining that the reference temperature and the device temperature are both greater than a cold threshold temperature and less than a hot threshold temperature; and determining that the computing device is in the uncertain environment. In some embodiments, determining the location context for the computing device further includes: determining that the reference temperature is warmer than the device temperature; determining that the device temperature is greater than a cold threshold temperature and less than a hot threshold temperature; and determining that the computing device is in the HVAC environment. In some embodiments, determining the location context for the computing device further includes: determining that the reference temperature is colder than the device temperature; determining that the device temperature is greater than a cold threshold temperature and less than a hot threshold temperature; and determining that the computing device is in the HVAC environment. In some embodiments, the location context further indicates whether the computing device is in the HVAC environment, the non-HVAC environment, or an uncertain environment; and determining the location context for the computing device further includes: determining that the reference temperature is colder than the device temperature; determining that the device temperature is near a cold threshold temperature within a low-end temperature deviation amount; and determining that the computing device is in the HVAC environment or the uncertain environment. In some embodiments, the location context further indicates whether the computing device is in the HVAC environment, the non-HVAC environment, or an uncertain environment; and determining the location context for the computing device further includes: determining that the reference temperature is warmer than the device temperature; determining that the device temperature is near a hot threshold temperature within a high-end temperature deviation amount; and determining that the computing device is in the HVAC environment or the uncertain environment. In some embodiments, determining the location context for the computing device further includes: determining that the reference temperature is colder than the device temperature; determining that the device temperature is below a cold threshold temperature; and determining that the computing device is in the non-HVAC environment. In some embodiments, the location context further indicates whether the computing device is in the HVAC environment, the non-HVAC environment, or an uncertain environment; and determining the location context for the computing device further includes: determining that the reference temperature is warmer than the device temperature; determining that the device temperature is above a hot threshold temperature; and determining that the computing device is in the uncertain non-HVAC environment. In some embodiments, determining the location context for the computing device further includes: determining the location context by comparing the device temperature and the reference temperature and further determining how the device temperature changes over time.

### BRIEF DESCRIPTION OF THE DRAWINGS

FIG. 1 is a simplified environment in which a barometric pressure sensor within a computing device can be calibrated or used to determine an altitude of the computing device, some of which may be subject to HVAC effects, in accordance with some embodiments.

FIG. 2 is a simplified flowchart of a procedure for correcting measurements of a barometric pressure sensor (of the computing device shown in FIG. 1) based on HVAC effects, in accordance with some embodiments.

FIG. 3 is a simplified flowchart of a procedure for determining the presence or magnitude of HVAC effects for use in the procedure shown in FIG. 2, in accordance with some embodiments.

FIG. 4 is a simplified graph of mapped altitude differences vs. time of day for different location contexts illustrating data clusters for use in the procedure shown in FIG. 3, in accordance with some embodiments.

FIGS. 5-7 are simplified flowcharts of example procedures for determining a likely location context of the computing device for use in the procedure shown in FIG. 2, in accordance with some embodiments.

FIG. 8 is a simplified graph of a reference temperature vs. a device temperature illustrating location contexts and changes in location contexts for use in the procedure shown in FIG. 7, in accordance with some embodiments.

FIG. 9 shows simplified graphs of a reference temperature and a device temperature vs. time of day illustrating relative differences in the reference temperature and the device temperature depending on location contexts and changes in location contexts for interpreting the data shown in FIG. 8, in accordance with some embodiments.

FIG. 10 shows simplified schematic diagrams of a transmitter, a computing device, and a server for use in the environment shown in FIG. 1, in accordance with some embodiments.

### DETAILED DESCRIPTION

Conventional systems or techniques for calibrating a barometric/atmospheric pressure sensor in a computing device or determining an altitude of the computing device when HVAC (heating, ventilation, and air-conditioning) effects may be a factor generally use data that is densely available in time, i.e., a data rich scenario in which data is collected relatively regularly and frequently. An example of such a technique is described in U.S. Pat. No. 10,477,358, which is incorporated herein by reference as if fully set forth herein. Such conventional techniques typically detect a sudden change in barometric pressure, which may indicate that the computing device has likely moved from a non-HVAC environment (i.e., an environment that is not subject to HVAC effects or biases) to an HVAC environment (i.e., an environment that is subject to HVAC effects) or vice versa or from a low HVAC environment (i.e., an environment that is subject to a relatively low HVAC effect) to a high HVAC environment (i.e., an environment that is subject to a relatively high HVAC effect) or vice versa. The “suddenness” of the pressure change is a consideration, because the transition between the two environments typically takes only a few seconds, e.g., the time it typically takes for a person to pass through a door. Thus, the sudden pressure change can generally be detected only with data that is collected relatively regularly and frequently, so that the point at which the pressure change occurs (i.e., when the change between the non-HVAC environment and the HVAC environment occurs) is evident in the pressure data with respect to time when the change is not accompanied by an apparent corresponding sudden altitude change. Thus, when the sudden pressure change is detected as a result of a movement of the computing device from one environment to another, it is readily apparent which of the two environments was subject to the HVAC effects, and any calibration or altitude determination technique can then properly take the HVAC effect into account for the relevant environment.

However, many situations can occur when the available data is relatively sporadic, instead of regularly occurring, thereby rendering such conventional systems or techniques inadequate, inappropriate or insufficient for producing a reliable calibration or altitude result. Sporadic data is data that is generally collected with insufficient regularity (i.e., not collected at regular intervals) and/or frequency (i.e., the data is too sparse or spread out with respect to time or distance) to render the sudden pressure change clearly evident in the pressure data. Without such regularity and frequency, the pressure change with respect to time might not indicate that the change was “sudden”, as typically happens with a transition from one environment to another. For example, regular/frequent data that tracks a computing device entering a single-story building and presenting a sharp jump in barometric pressure could indicate that the building is subject to HVAC effects, but if there were only one data collection event (i.e., an example of sporadic data) inside the building with no other context, there would not be enough information to draw a conclusion of whether there is an HVAC effect, since a pressure delta would require at least two measurements. In another example, if the time period between successive data collections is so large (i.e., another example of sporadic data) that a ratio of the measured pressure change with respect to time is negligible, there would also not be enough information to draw a conclusion of whether there is an HVAC effect. There is, thus, a temporal dimension or a spatial dimension or both in the qualitative and quantitative difference between sporadic data and regular data. Sporadic data is less dense or less consistent than regular or dense data. Sporadic data is not collected at regular intervals (i.e., is randomly collected) or is more spread out in time or distance than regular data. The techniques described herein have the advantage or improvement of being able to work with both sporadic data and regular data, instead of just regular data.

In a simplified summary of the techniques described herein, a likely location context for the computing device (and the user thereof) is first determined. In other words, it is determined whether the computing device is apparently in a vehicle (whether moving or stopped), a building, or some other environment that is potentially subject to HVAC effects. Then a measured altitude or pressure at such times is compared to those at other times when the computing device is apparently NOT in a vehicle, a building, or some other environment that is potentially subject to HVAC effects. In this manner, magnitudes of altitude differences or pressure differences can be compared across different data collection environments. With the altitude differences or pressure differences, the existence of HVAC push/pull effects to the ambient pressure are identified and/or quantified. Identified instances where there exists a push or pull in the pressure measurement of the barometric pressure sensor of the computing device aid in calibration of the pressure sensor or accurate determination of an altitude of the computing device. (A “push” is defined herein to be an increase in the measured pressure, which corresponds to a lower calculated altitude compared to the actual altitude; and a “pull” is defined herein to be a decrease in the measured pressure, which corresponds to a higher calculated altitude compared to the actual altitude.)

Since the techniques described herein can work with both sporadic data and regular data, this improves upon the opportunities for and accuracy of altitude estimations of the computing device. Additionally, some aspects of the disclosure herein improve the determination of a more appropriate uncertainty in the estimated altitude of the computing device. In addition, calibration of the pressure sensor is improved by helping to filter out unreliable or less desirable data points or ensuring that the uncertainty in the calibration result is more appropriate. The resulting improved calibration value for the pressure sensor of the computing device improves the accuracy of the estimated altitude of the computing device. Therefore, the disclosure herein represents a specific set of rules in a process flow that provides significant advantages in the fields of calibration and position/altitude determination.

The benefits or advantages of the present disclosure are particularly significant in a situation where a user calls an emergency service such as 911 from within a high-rise office building during a life-or-death situation. In such a situation, a floor designator that indicates which floor of the building the user is on may be significantly more useful to the first responders or emergency personnel trying to reach the user as compared to receiving a raw estimated altitude value reported by the user's computing device. Therefore, the improved technique described herein for determining the altitude of the computing device (e.g., with better calibration of the pressure sensor therein or improved altitude estimation) can be combined with a technique for determining the floor most likely to correspond to the determined altitude (e.g., as described in US Patent Publication No. 2023/0384087), and thereby improve emergency service response times. (US Patent Publication No. 2023/0384087 is incorporated herein by reference as if fully set forth herein.) In this case, if the user is calling from within a multi-floor building, then the emergency 911 service would require the floor number in order to properly dispatch an emergency medical team to the correct floor. However, if the user cannot provide the floor number, then the 911 app on the computing device or a server must provide it, i.e., correct knowledge of the floor number (or altitude of the computing device) can be critical for the emergency medical team to search for and find the user on the correct floor in a timely manner. Since the building is likely to be an environment that is subject to HVAC effects, the present disclosure can aid in making the determination of the most likely floor or a more accurate range of floors.

Additionally, there are a wide range of useful software applications that operate on computing devices and that require knowledge of the altitude of the computing device to operate properly or effectively. In some examples, some such applications simply inform the user of the computing device of their current location, including their altitude, for whatever personal purpose the user might have or feel a need for. In a specific example, the user might want to use an app on the computing device to receive electronic discounts or special advertisements for a retail store upon entering the store. However, if the store is in a shopping mall that has more than one floor, then the app needs to know which floor the computing device is on in order to operate properly, i.e., the app requires knowledge of the altitude of the computing device so that it can compare this altitude with the altitudes of the floors and make a proper determination of whether the user is likely to be in the correct store. Since the shopping mall or the store could be an environment that is subject to HVAC effects, the present disclosure can aid in making the determination of whether the user and computing device are in the correct store.

The examples in the previous paragraphs highlight the importance, even life-saving criticality, of a good altitude determination for a computing device in various situations, especially in situations that are subject to HVAC effects. However, there is usually some amount of uncertainty in the determined altitude value. Given the importance of a proper altitude determination, it is necessarily of equal importance to provide the altitude value with a high degree of certainty (i.e., a low degree of uncertainty) or a good determination of the uncertainty. In the critical example given above, the emergency medical team can be provided with the likely floor number for the computing device and the user, but with a further level of likelihood of whether the user could be on the next floor above or below, so that the emergency medical team can know whether to expand their search for the user to these other floors. Proper consideration of potential HVAC effects, even with sporadic data as described herein, can significantly improve the search for the user.

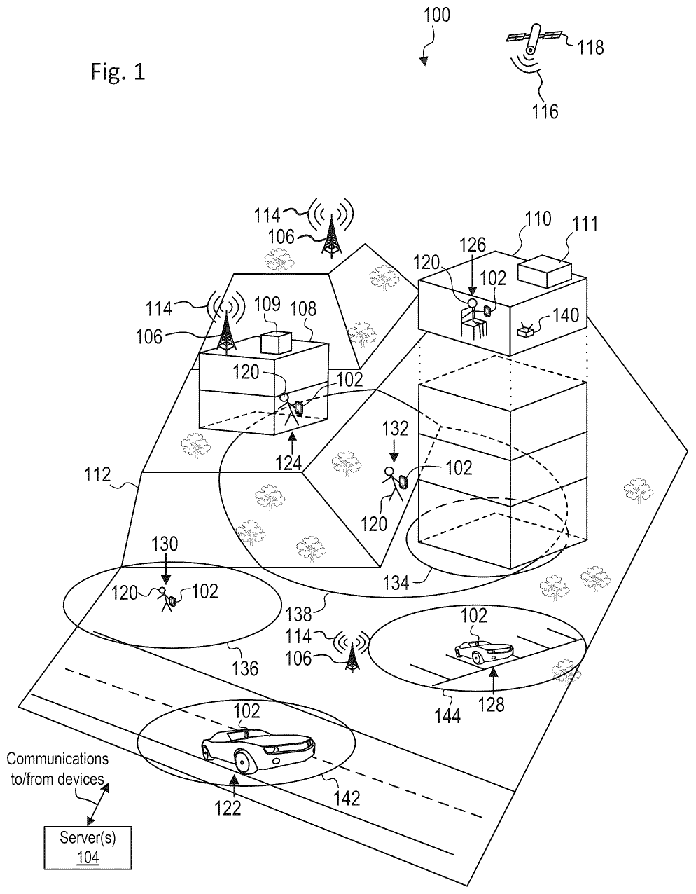

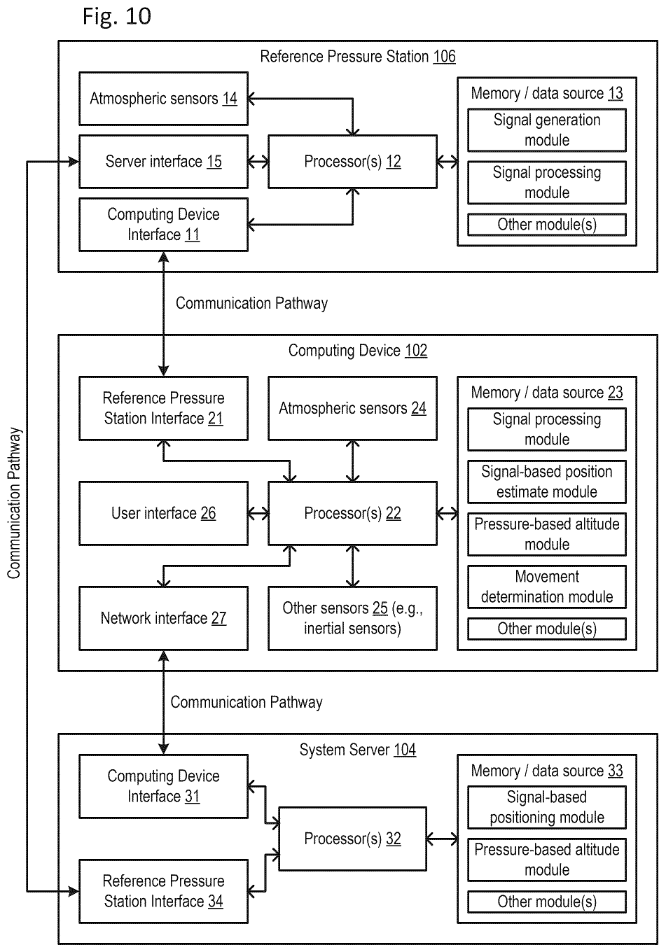

FIG. 1 shows a simplified example operational environment 100 in which a barometric pressure sensor within a computing device 102 (e.g., a mobile user device) can be calibrated or used to determine an altitude of the computing device 102, in accordance with some embodiments. The operational environment 100 includes at least one of the computing devices 102, one or more system servers 104, and a network of terrestrial transmitters or reference pressure stations 106. The system server 104 exchanges communications with various devices, such as the computing device 102. Each of the reference pressure stations 106 and the computing device 102 may be located at different altitudes or depths that are inside or outside various natural or manmade structures (e.g., buildings 108 and 110), relative to different elevations throughout a terrain 112, as illustrated by examples in FIG. 1. Positioning signals 114 and 116 are transmitted from the reference pressure stations 106 and satellites 118 (e.g., part of a Global Navigation Satellite System (GNSS)), respectively, and are subsequently received by the computing device 102 using known transmission technologies. For example, the reference pressure stations 106 may transmit the signals 114 using one or more common multiplexing parameters that utilize time slots, pseudorandom sequences, frequency offsets, or other approaches, as is known in the art or otherwise disclosed herein. Examples of possible hardware, software and data components in the reference pressure stations 106, the computing device 102, and the system server 104 are shown in FIG. 10, as described below. In particular, each reference pressure station 106 and computing device 102 may include atmospheric sensors (e.g., barometric pressure sensors and temperature sensors, as appropriate) for generating measurements of atmospheric conditions (e.g., atmospheric pressure and temperature) that are used to estimate an altitude of the computing device 102 or to calibrate the barometric pressure sensor therein.

As a person/user 120 carrying the computing device 102 moves throughout such an example operational environment 100, the computing device 102 may experience a variety of activities or diversity of locations both indoors and outdoors. For example, the computing device 102 may be moving rapidly (e.g., location changes significantly in a relatively short time) when it is in a vehicle (as on a road at 122) that the user is driving or riding in. In another example, the computing device 102 may be still or moving slowly (e.g., as indicated by an accelerometer or GNSS signals or other positioning sensor within the computing device 102) when the user 120 is simply standing, sitting, or walking (e.g., as in a building at 124 or 126, in a parked vehicle at 128, or walking outdoors at 130 or 132).

An environment characterized by HVAC or which is subject to HVAC effects is an environment where the air is warmed or cooled and/or filtered or cycled, usually by a specialized HVAC system. HVAC systems can add or remove additional air mass into or from an enclosed environment in a controlled fashion and can cause such an environment to increase or decrease in pressure-a well-understood phenomenon. However, artificial pressurization (positive or negative) can strongly affect a barometric-based altitude system, where barometric pressure measured by a barometric pressure sensor of a computing device is used in conjunction with ambient information such as a reference pressure and temperature to calculate the altitude of the computing device. Altitudes measured in such environments can typically be biased lower or higher due to the HVAC push or pull, respectively, so the true altitude of the computing device is not directly reflected by the raw pressure data from the pressure sensor thereof.

In FIG. 1, the environments that are potentially subject to HVAC effects are the buildings 108 and 110 (having HVAC systems 109 and 111, respectively) and the vehicles at 122 or 128. However, other types of environments not represented in FIG. 1 may also be subject to HVAC effects, e.g., any enclosed environment that has an HVAC system. Additionally, a further complication for the vehicles may be caused by high wind speed effects due to the movement of the vehicles.

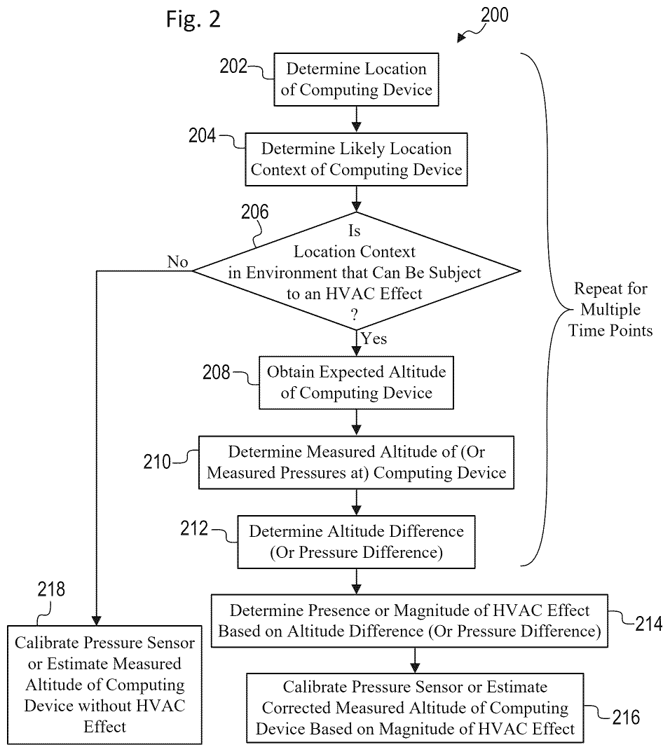

FIG. 2 is a simplified flowchart of an example process 200 for correcting measurements of a barometric pressure sensor (of the computing device 102) based on HVAC effects, in accordance with some embodiments. The process 200 can work with sporadic data as well as regular data, so the process 200 enables or embodies all of the advantages, benefits or improvements described herein. The particular steps, combination of steps, and order of the steps for this process are provided for illustrative purposes only. Other processes with different steps, combinations of steps, or orders of steps can also be used to achieve the same or similar result. Features or functions described for one of the steps performed by one of the components may be enabled in a different step or component in some embodiments. Additionally, some steps may be performed before, after or overlapping other steps, in spite of the illustrated order of the steps.

Some of the steps of the process 200 use the location of the computing device 102. Therefore, in some embodiments, upon starting or at any appropriate point, the process 200 determines (at 202) the 2D or an approximate 3D location of the computing device 102 using conventional location/position techniques.

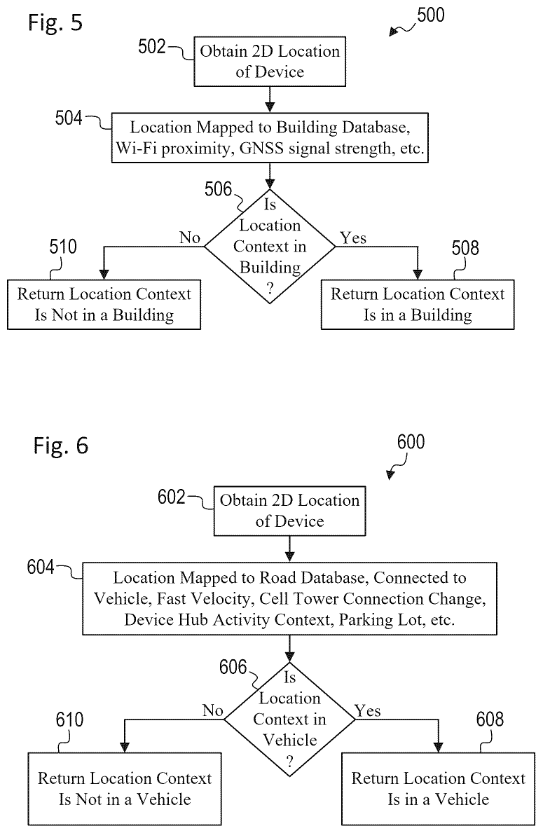

At 204, the process 200 determines the likely location context of the computing device 102. The location context can be determined using a variety of different techniques. FIGS. 5-9, described below, illustrate three example techniques for determining the location context. The processes of FIGS. 5 and 6, for example, use the location determined at 202 to determine the location context. In particular, the process of FIG. 5 determines whether the computing device 102 is in a building, and the process of FIG. 6 determines whether the computing device 102 is in a vehicle. On the other hand, FIGS. 7-9 illustrate a process that does not use a location context that is based on the location determined at 202 but infers the location context based on temperature considerations, so this process does not specify the type of location context, e.g., in a building or vehicle. In some embodiments, therefore, at 204, the process 200 performs any one or more of the processes of FIGS. 5-9.

The determined location context is generally related to whether the computing device 102 is likely to be in an environment that can be subject to an HVAC effect, e.g., inside a building, a vehicle, or other enclosed environment that might have an HVAC system. In some embodiments, therefore, the returned result of any one or more of the processes of FIGS. 5-9 may state that the computing device 102 either is or is not in a building (FIG. 5), a vehicle (FIG. 6), or any other environment that can be subject to an HVAC effect (FIGS. 7-9).

At 206, the process 200 determines whether the location context of the computing device 102 is an environment that can be subject to an HVAC effect, e.g., as indicated by the returned result of any one or more of the processes of FIGS. 5-9 at 204. Therefore, the determination at 206 is negative or “No” if the returned result of the process of FIG. 5 states that the computing device 102 is not in a building, the returned result of the process of FIG. 6 states that the computing device 102 is not in a vehicle, and the returned result of the process of FIGS. 7-9 states that the computing device 102 is not in any environment that can be subject to an HVAC effect. In this case, the process 200 proceeds at 218 to perform any functions that do not take into account HVAC effects, e.g., calibrate the pressure sensor of the computing device 102 or estimating a measured altitude of the computing device 102 without any adjustment for HVAC effects.

On the other hand, the determination at 206 is positive or “Yes” if the returned result of the process of FIG. 5 states that the computing device 102 is in a building, the returned result of the process of FIG. 6 states that the computing device 102 is in a vehicle, or the returned result of the process of FIGS. 7-9 states that the computing device 102 is in any environment that can be subject to an HVAC effect. In this case, the process 200 proceeds to perform the following functions at 208-216 to take into account or quantify (i.e., determined the magnitude of) potential HVAC effects.

In some embodiments, at 208, the process 200 obtains an expected altitude (i.e., a lookup altitude) of the computing device 102. The expected altitude can be determined by a conventional technique based on the location of the computing device 102 (e.g., as determined at 202) and an altitude indicated for that location in a terrain or building database (e.g., a terrain lookup, a building floor altitude lookup, etc.). In some embodiments, the expected altitude can be obtained with help from the user of the computing device 102, e.g., by receiving floor level input from the user when the user is in a multi-level building or shopping mall and then performing a building floor altitude lookup. In some embodiments, at 210, the process 200 determines a measured altitude (i.e., a barometric altitude) of the computing device 102 using conventional techniques, e.g., using a barometric formula based on a measured pressure value from the pressure sensor of the computing device 102 and a reference pressure and reference temperature obtained from a network of reference atmospheric sensors (e.g., the reference pressure stations 106 in FIG. 1) in the same general area as the location of the computing device 102. The measured pressure value may or may not be subject to HVAC effect, so if an HVAC effect is determined in the subsequent steps, then the measured altitude (i.e., an initial altitude) calculated from the measured pressure value will be corrected at the end of the process 200 (i.e., a corrected measured altitude).

In some embodiments, at 212, the process 200 determines an altitude difference between the expected altitude and the measured altitude. The altitude difference may be calculated as: altitude difference=measured altitude−expected altitude. For example, if the measured altitude was 19 m and the expected altitude based on terrain data at the given location of the computing device 102 was 7 m, then assuming that the computing device 102 is offset above the ground by about 1 m, the altitude difference is 19−(7+1)=11 m. However, if the expected altitude of the computing device 102 could not be unambiguously determined via a terrain or building data lookup or other available means, such as user intervention (for example, in a situation where the computing device 102 is within a building having multiple floors), then the current dataset using the location context of the computing device 102 might not be useable and may have to be discarded.

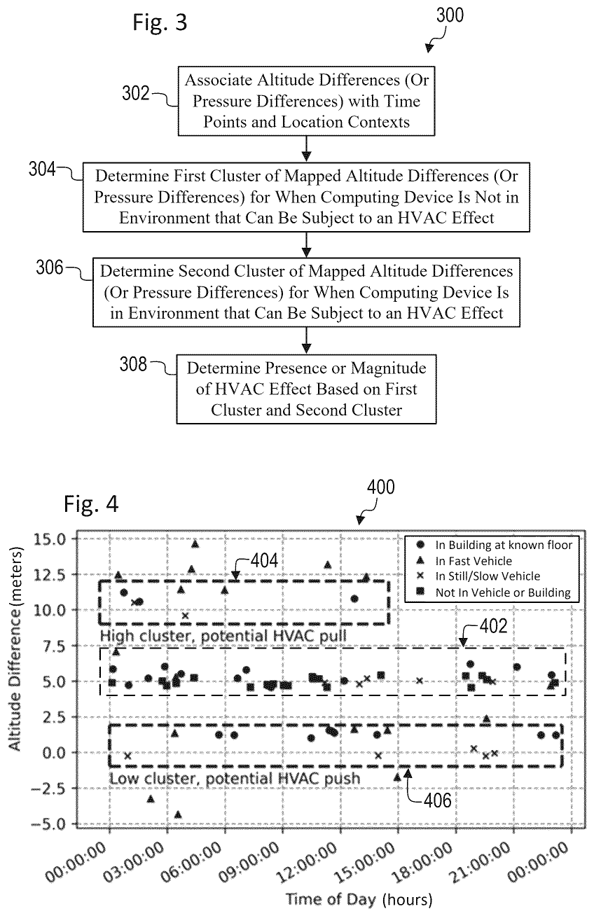

At 214, the process 200 determines and stores the presence or magnitude of the HVAC effect for a given environment based on the altitude difference. In some embodiments, the process 200 at steps 202-212 is repeated for multiple time points in order to generate multiple datasets for determining the presence of or magnitude of the HVAC effects of the given environment. An example process for determining the presence or magnitude of HVAC effects at 214 using multiple datasets is described below with reference to FIGS. 3 and 4.

In some embodiments, a database is generated for the magnitude of the HVAC effect for known buildings or vehicles. Therefore, when any computing device 102 is in a known building or vehicle, then the magnitude of the HVAC effect can be looked up in the database and used to determine the altitude of the computing device 102 and, if necessary, to calibrate the pressure sensor therein. Additionally, the database may store the HVAC effect magnitude relative to the days of the week, the outdoor temperature, the season, or other appropriate parameter.

At 216, the process 200 uses the determination made at 214. In some embodiments, the process 200 uses the magnitude of the HVAC effect to estimate a corrected measured altitude of the computing device 102. For example, the measured altitude that was determined at 210 is adjusted or corrected by subtracting the magnitude of the HVAC effect therefrom, and an associated uncertainty is also corrected based on an uncertainty due to the HVAC effect. In some embodiments, it may be necessary to calibrate the pressure sensor in spite of the data being affected by HVAC effects, so the process 200 uses the magnitude of the HVAC effect to calculate a calibration value and a calibration uncertainty value for the pressure sensor. For example, a conventionally determined calibration value and calibration uncertainty value are further adjusted for the HVAC effect and the uncertainty that it represents. In some embodiments, the process 200 uses the mere presence of the HVAC effect to determine not to calibrate the pressure sensor or estimate the altitude of the computing device 102 using the HVAC-affected data, e.g., due to the possibility that the HVAC effect would render the resulting calibration value or altitude too uncertain. In some embodiments, if there is a potential HVAC effect present, then it may be preferable to use a previously determined calibration value and uncertainty.

The description above of steps 208-214 describes an altitude-based version of the process 200. However, in some embodiments, a pressure-based version may be employed. In this case, the process 200 need not obtain the expected altitude of the computing device 102 at 208. Therefore, if the determination at 206 is positive or “Yes”, then the process 200 proceeds to 210.

At 210, the process 200 determines at least two measured pressures, which may be from the same computing device 102 or two different computing devices 102, i.e., a single-device embodiment and a two-device embodiment. (The two-device embodiment may generally be performed if the two devices are known to be well-calibrated.) One of the pressure measurements is taken when the location context of the computing device 102 is an environment that is not subject to an HVAC effect, and the other pressure measurement is taken when the location context of the (same or different) computing device 102 is an environment that can be subject to an HVAC effect. Additionally, the time difference between the two pressure measurements is preferably relatively brief, e.g., about 10 minutes or less, so that any change in the actual ambient atmospheric pressure between the two measurements is likely to be negligible (e.g., about 5 Pa or less). In this situation, it can be assumed that the ambient pressure has not changed significantly in this time period. Furthermore, unless it is known that the altitudes of the two locations are the same, then the distance between the two locations at which the two measurements are taken is preferably relatively small, so that the altitude of the computing device 102 at the two locations can be assumed to be almost the same. Thus, it can be assumed that the user has not traversed with the computing device 102 (for the single-device embodiment) a large enough distance (e.g., moved about 200 m or more) or that the two computing devices 102 are not too far apart (for the two-device embodiment) for a relatively large horizontal pressure gradient (e.g., about 10 Pa/km or more) to be significant. If these conditions are met, then the process 200 can compare the pressure difference between the two measurements instead of the altitude difference, and the pressure difference can be assumed to be primarily caused by the difference between the HVAC environment and the non-HVAC environment.

Therefore, at 212, the pressure difference is determined or calculated as: pressure difference=first barometric pressure−second barometric pressure. As an example, if the location context of the computing device 102 at a first point is determined to be in a parked vehicle and the measured pressure is 100100 Pa, and the location context of the (same or different) computing device 102 at a second point (less than 200 m away from and less than 10 min after the first point) is determined not to be in the parked vehicle (or a building or other HVAC environment) and the measured pressure is 100050 Pa, then the pressure difference is 50 Pa.

An additional benefit of the pressure-based version of the process 200 is that a reference pressure and temperature lookup is not required as it is for determining the measured altitude described above.

FIG. 3 is a simplified flowchart of a process 300 (both an altitude-based version and a pressure-based version) for determining the presence or magnitude of HVAC effects at step 214 (FIG. 2), in accordance with some embodiments. The particular steps, combination of steps, and order of the steps for this process are provided for illustrative purposes only. Other processes with different steps, combinations of steps, or orders of steps can also be used to achieve the same or similar result. Features or functions described for one of the steps performed by one of the components may be enabled in a different step or component in some embodiments. Additionally, some steps may be performed before, after or overlapping other steps, in spite of the illustrated order of the steps.

In some embodiments of the altitude-based version, at 302, the process 300 associates the altitude differences (e.g., as determined at 212 for multiple time points) with the corresponding time points and location contexts. An example for how the altitude differences, time points, and location contexts can be associated is shown in FIG. 4. FIG. 4 is a simplified graph 400 of simulated data for mapped or graphed altitude differences vs. time of day for different location contexts that shows clusters of the data.

The data shown with circles represent a location context of the computing device 102 being in a building at the same known floor. The data shown with triangles represent a location context of the computing device 102 being in a vehicle that is travelling relatively fast. The data shown with exes (“X”) represents a location context of the computing device 102 being in a vehicle that is still or travelling relatively slowly. The data shown with squares represents a location context of the computing device 102 not being in either a building or a vehicle.

The data is generally distributed in three data clusters 402, 404 and 406, which can be determined using conventional data clustering techniques. For example, at 304, the process 300 determines a first cluster (e.g., a middle data cluster 402) of the mapped altitude differences for when the computing device 102 appears not to be in an environment that can be subject to an HVAC Effect. Additionally, at 306, the process 300 determines one or more second clusters (e.g., data clusters 404 and 406) of the mapped altitude differences for when the computing device 102 is in an environment that can be subject to an HVAC Effect. The data cluster 404 is a high cluster that represents a potential HVAC pull effect, since an HVAC pull results in a lower air pressure, which is generally associated with a higher altitude; and the data cluster 406 is a low cluster that represents a potential HVAC push effect, since an HVAC push results in a higher air pressure, which is generally associated with a lower altitude. As can be seen, the altitude differences for each data cluster 402, 404 and 406 generally fall relatively close together within their cluster throughout the time of day.

Additionally, data points that fall outside of the clusters may be considered to be extreme anomalies that should be discarded, instead of included for use in the determination of the HVAC effect. For example, some of the data points for the vehicle that is travelling relatively fast (i.e., the triangles) might fall above the high cluster 404 or below the low cluster 406, which might be expected due to the high wind effect of the fast moving vehicle, especially if the vehicle's windows were open, but also to some extent when the windows are closed. In this case, the wind effect could render any quantification of the HVAC effect unreliable, so such extreme data points should preferably be discarded or removed from further calculations. For example, these extreme data points should not be used for calibration purposes. However, there might be situations in which an altitude may have to be determined using such an extreme data point, since there may be no other option. Nevertheless, datapoints taken in a location context of a moving vehicle are preferably discarded before a calibration calculation is performed, because such datapoints are typically noisy.

The data points for the location context of the computing device 102 not being in either a building or a vehicle (i.e., the squares) are all as expected within the middle data cluster 402 for when the computing device 102 is not in an environment that can be subject to an HVAC Effect. On the other hand, the other data points for the building or vehicle (i.e., circles, triangles, and Xs) appear mostly to fall within each data cluster 402, 404 and 406. For example, when the HVAC system of the building or vehicle is not blowing air, then there might not be any HVAC pull or push effect, in which case, the data points for the building or vehicle may fall within the middle data cluster 402. Additionally, when a window of a building or slowly moving vehicle is open, then this can negate any HVAC effect even when the HVAC system is blowing air, in which case, such environments that are open to ambient pressure may be considered “not well-sealed” or “leaky”, and the data points for the building or vehicle may fall within the middle data cluster 402. On the other hand, when the HVAC system of the building or vehicle is blowing air into an area of the building or vehicle, then there is an HVAC push effect, in which case, the data points for the building or vehicle may fall within the low data cluster 406. However, when the HVAC system of the building or vehicle is blowing air out of an area of the building or vehicle, then there is an HVAC pull effect, in which case, the data points for the building or vehicle may fall within the high data cluster 404. Additionally, some buildings or vehicles (or areas or rooms thereof) may experience only an HVAC push effect and not an HVAC pull effect, or vice versa, so only one of the two high/low data clusters 404 and 406 might be seen.

The data points within the middle data cluster 402 generally represent situations in which the computing device 102 is not in an environment that can be subject to an HVAC Effect (e.g., when outdoors) or is not in an environment that is currently subject to an HVAC Effect (e.g., when the HVAC system is not currently blowing/moving air). The data in the middle data cluster 402 is indicative of overall bias in the altitude difference and can thus reliably be used to calibrate the pressure sensor of the computing device 102, i.e., calculate a calibration value and a calibration uncertainty value as described, for example, in U.S. Pat. Nos. 11,555,699 and 11,073,441, but no HVAC effect can be determined from this data. (U.S. Pat. Nos. 11,555,699 and 11,073,441 are incorporated herein by reference as if fully set forth herein.) Additionally, the data in the middle data cluster 402 can also reliably be used to determine/estimate an altitude of the computing device 102. However, to be certain that there were no data points that were subject to HVAC effects, the data points for the location contexts in a building or vehicle (i.e., circles, triangles, and Xs) within the middle data cluster 402 may be excluded from the calibration or altitude calculations. Various conventional calibration techniques can thus be used to obtain a calibration value which, in the illustrated example, would be about 5-6 meters. These calibration and altitude calculations may be done similarly to step 218 in the process 200, since they are done without HVAC effects.

At 308, the presence or magnitude of the HVAC effect is determined based on the middle data cluster 402 (i.e., a first cluster) and the high or low data cluster 404 or 406 (i.e., a second cluster). In other words, the data points in the high data cluster 404 relative to the data points in the middle data cluster 402 can be used to determine or quantify a magnitude of an HVAC pull effect for the building or vehicle (or area or room therein) within which the measurements for the data points were taken. Likewise, the data points in the low data cluster 406 relative to the data points in the middle data cluster 402 can be used to determine or quantify a magnitude of an HVAC push effect for the building or vehicle (or area or room therein) within which the measurements for the data points were taken. For example, in some embodiments, a first, second and third average, central tendency, or median of the data points in the middle data cluster 402, the data points in the high data cluster 404, and the data points in the low data cluster 406, respectively, are calculated (depending on availability of data for a given building or vehicle). Then the magnitude of the HVAC pull effect for a building or vehicle is determined based on a difference between the first average (for the middle data cluster 402) and the second average (for the high data cluster 404), e.g., HVAC pull effect magnitude=first average−second average. Similarly, the magnitude of the HVAC push effect for a building or vehicle is determined based on a difference between the first average (for the middle data cluster 402) and the third average (for the low data cluster 406), e.g., HVAC push effect magnitude=first average third average. The HVAC effect magnitude is then returned to step 214 of the process 200. If the HVAC effect magnitude (push or pull) is about equal to or greater than a typical height of a building floor (e.g., about +/−3 m) or half this height value, then the HVAC effect could cause the resulting altitude calculation to indicate that the computing device 102 is on the next floor above or below the actual floor. Additionally, a “difference threshold” may be established as an indicator for whether potential HVAC effects are likely to be present and should be taken into account. For example, if the data cluster 404 or 406 is less than the difference threshold (i.e., a relatively small difference value, e.g., about 1-2 m) from the middle data cluster 402, then the altitude difference may be considered to be due to noise rather than an HVAC effect. Therefore, in some embodiments, the altitude difference for the data cluster 404 or 406 may be used to determine the HVAC effect only when the altitude difference is greater than or equal to the difference threshold.

In some embodiments, the time of day data is used at 308 to determine different HVAC push/pull effect magnitudes for a building or vehicle that may be likely to occur at different times of day. Similar to the time of day, in some embodiments, time of year data is used at 308 to determine different HVAC push/pull effect magnitudes for a building or vehicle that may be likely to occur at different times of the year.

In some embodiments, instead of quantifying the HVAC effect, the process 300 merely determines at 308 whether an HVAC effect is likely to be present. Thus, the magnitude need not be calculated in this case. For example, the data points in the clusters 404 and 406 are indicative of the presence of an HVAC effect, regardless of the magnitude thereof. In some embodiments, data points simply being outside of (i.e., above or below) the central/middle data cluster 402 are indicative of the presence of an HVAC effect for these data points. In such cases, at 308, the process 300 returns a flag or other indication that there is likely an HVAC effect (without a magnitude thereof) to the process 200 at 214, so that the process 200 can use the mere presence of the HVAC effect to determine (at 216) not to calibrate the pressure sensor or estimate the altitude of the computing device 102 using the HVAC-affected data, e.g., due to the possibility that the HVAC effect would render the resulting calibration value or altitude too uncertain. In such cases, it may be preferable to use a previously determined calibration value and uncertainty.

In some embodiments of the pressure-based version of the process 300, at 302, the process 300 associates (i.e., maps) the pressure differences (e.g., as determined at 212 for multiple time points) with the corresponding time points and location contexts. The example of FIG. 4 can be used to illustrate how the pressure differences, time points, and location contexts can be associated. As above, the location context is indicated by the circles, triangles, Xs, and squares.

The pressure difference data is distributed in clusters that are generally the same as the data clusters 402, 404 and 406 but with reversed descriptions and tighter restrictions on duration length and spatial separations. For example, at 304, the process 300 determines a first cluster (e.g., a middle data cluster 402) of the mapped pressure differences for when the computing device 102 is not in an environment that can be subject to an HVAC Effect. Additionally, at 306, the process 300 determines one or more second clusters (e.g., data clusters 404 and 406) of the mapped pressure differences for when the computing device 102 is in an environment that can be subject to an HVAC Effect. The data cluster 404 is a high cluster that represents a potential HVAC push effect, since an HVAC push results in a higher air pressure, which is generally associated with a lower altitude. Thus, when the HVAC system of the building or vehicle is blowing air into an area of the building or vehicle, then there is an HVAC push effect, in which case, the data points for the building or vehicle may fall within the high data cluster 404. Additionally, the data cluster 406 is a low cluster that represents a potential HVAC pull effect, since an HVAC pull results in a lower air pressure, which is generally associated with a higher altitude. Thus, when the HVAC system of the building or vehicle is blowing air out of an area of the building or vehicle, then there is an HVAC pull effect, in which case, the data points for the building or vehicle may fall within the low data cluster 406. The pressure differences for each data cluster 402, 404 and 406 generally fall relatively close together within their cluster throughout the time of day.

As above, data points that fall outside of the clusters may be considered to be extreme anomalies that should preferably be discarded, instead of included for use in the determination of the HVAC effect or a calibration.

Similar to the description above, at 308, the presence or magnitude of the HVAC effect is determined based on the middle data cluster 402 (i.e., a first cluster) and the high or low data cluster 404 or 406 (i.e., a second cluster). In other words, the data points in the high data cluster 404 relative to the data points in the middle data cluster 402 can be used to determine or quantify a magnitude of an HVAC push effect for the building or vehicle (or area or room therein) within which the measurements for the data points were taken. Likewise, the data points in the low data cluster 406 relative to the data points in the middle data cluster 402 can be used to determine or quantify a magnitude of an HVAC pull effect for the building or vehicle (or area or room therein) within which the measurements for the data points were taken.

FIG. 5 is a simplified flowchart of an example process 500 for determining (e.g., at step 204 in FIG. 2) whether the computing device 102 is in a building, in accordance with some embodiments. The particular steps, combination of steps, and order of the steps for this process are provided for illustrative purposes only. Other processes with different steps, combinations of steps, or orders of steps can also be used to achieve the same or similar result. Features or functions described for one of the steps performed by one of the components may be enabled in a different step or component in some embodiments. Additionally, some steps may be performed before, after or overlapping other steps, in spite of the illustrated order of the steps.

At 502, the process 500 obtains the two dimensional (i.e., 2D or horizontal) location of the computing device 102. For example, the location determined at 202 may be used.

At 504, one or more of several techniques, tests or options may be used to determine if it is likely that the computing device 102 is inside a building (e.g., building 108 or 110 in FIG. 1). If any of these techniques indicates (as determined at 506) that the location context of the computing device 102 is likely to be in a building, then the process 500 proceeds to 508 to return an indicator to the process 200 (at 204) that the location context is in a building. On the other hand, if none of these techniques indicates (at 506) that the location context of the computing device 102 is likely to be in a building, then the process 500 proceeds to 510 to return an indicator to the process 200 (at 204) that the location context is not in a building.

In some embodiments, for example, the 2D location (e.g., the latitude and longitude and optionally 2D uncertainty) of the computing device 102 are mapped to a terrain or building database that provides the locations of buildings in the general area of the 2D location. This mapping would, thus, indicate whether the computing device 102 is in the building. The 2D location and uncertainty, for example, might indicate that the computing device 102 is within a location area 134 shown in FIG. 1. A large portion of the location area 134 maps to the building 110 (e.g., a key ratio between the device footprint of the computing device 102 and the building footprint of the building 110 is above an appropriate threshold value), so there is a high likelihood that the computing device 102 is within this building, e.g., at 126. In this case, the process 500 branches to 508 to return to the process 200 (at 204) that the location context is in a building.

On the other hand, the 2D location and uncertainty, for example, might indicate that the computing device 102 is within a location area 136 shown in FIG. 1 (e.g., when the computing device 102 is at 130). No portion of the location area 136 maps to a building, so there is a low likelihood that the computing device 102 is within any building. In this case, the process 500 branches to 510 to return to the process 200 (at 204) that the location context is not in a building.

In contrast, the 2D location and uncertainty, for example, might indicate that the computing device 102 is within a location area 138 shown in FIG. 1. A first portion of the location area 138 maps to the building 110 (as if the computing device 102 was at 126), and second portion of the location area 138 maps to the building 108 (as if the computing device 102 was at 124), but a third portion of the location area 138 does not map to any building (as if the computing device 102 was outdoors at 132). Depending on the key ratio between the device footprint and the building footprint of either of the buildings 108 or 110, the process 500 makes the appropriate determination of whether the computing device is within one of the buildings 108 or 110 or is not within any building and returns (at 508 or 510) to the process 200 (at 204) the appropriate location context that the computing device 102 is in a building or not in a building. Additionally, in some embodiments, the location context may specify which building the computing device 102 is in, because different buildings could have different HVAC effects. As illustrated, the portion of the location area 138 that does not map to any building appears to be much larger than either of the other portions, so in this example the process 500 returns (at 510) to the process 200 (at 204) the location context that the computing device 102 is not in a building.

In a situation where a user (with the computing device 102) is standing on a rooftop of a building or parking garage, the environment would be a non-HVAC environment, since it would be open to the ambient environment. In some embodiments, therefore, a 3D location including an initial altitude determination (and optionally 3D uncertainty) are made at 502, so that the 2D location and the possible altitude are taken into account (e.g., within given horizontal and vertical thresholds) in determining whether the computing device 102 is inside a building.

In some embodiments, the process 500 determines (at 504) a proximity or connection of the computing device to a wireless access point (WAP) 140 (e.g., a Wi-Fi transceiver or router), the location of which is known to be in a building, because a wireless connection to the WAP would indicate that the computing device 102 is within the building. In this case, if the WAP 140 is known to be inside a multi-floor building (as shown in building 110), and the process 500 determines that the computing device 102 is wirelessly connected to the WAP 140, then the process 500 further determines that the computing device 102 is inside the building 110. Thus, the process 500 branches to 508 to return to the process 200 (at 204) that the location context is in a building.

In some embodiments, the process 500 determines (at 504) a GNSS signal strength, e.g., of the positioning signal 116 from the satellite 118. In this case, when the strength of the satellite signal is attenuated from the level that it should be if the computing device 102 were outdoors with a direct line-of-sight access to the satellite 118, then this indicates that the computing device 102 is not outdoors with a direct line-of-sight access to the satellite 118, so the process 500 determines that the computing device 102 is likely to be indoors and, thus, likely to be in a building, e.g., at 124 in building 108 or at 126 in building 110. Thus, the process 500 branches to 508 to return to the process 200 (at 204) that the location context is in a building.

In some embodiments, the process 500 performs each of the above-described techniques (among others) for determining if the computing device 102 is in a building. If any one of these techniques indicates that the computing device 102 is in a building, then the process 500 branches to 508 to return to the process 200 (at 204) that the location context is in a building. However, if none of these techniques indicates that the computing device 102 is in a building, then the process 500 branches to 510 to return to the process 200 (at 204) that the location context is not in a building.

FIG. 6 is a simplified flowchart of an example process 600 for determining (e.g., at step 204 in FIG. 2) whether the computing device 102 is in a vehicle, in accordance with some embodiments. The particular steps, combination of steps, and order of the steps for this process are provided for illustrative purposes only. Other processes with different steps, combinations of steps, or orders of steps can also be used to achieve the same or similar result. Features or functions described for one of the steps performed by one of the components may be enabled in a different step or component in some embodiments. Additionally, some steps may be performed before, after or overlapping other steps, in spite of the illustrated order of the steps.

At 602, the process 600 obtains the two dimensional (i.e., 2D or horizontal) location of the computing device 102. For example, the location determined at 202 may be used.

At 604, one or more of several techniques, tests or options may be used to determine if it is likely that the computing device 102 is inside a vehicle (e.g., at 122 or 128 in FIG. 1). For example, if measurements from the pressure sensor of the computing device 102 over a relatively short period of time are relatively noisy, i.e., exhibit relatively large differences, then it can be inferred that the computing device 102 is in a rapidly moving vehicle. On the other hand, if the differences between such pressure measurements are below an appropriate noise threshold, then it may be difficult to distinguish between walking, biking, and some traffic activities. Therefore, the techniques used at 604 to determine if it is likely that the computing device 102 is in a vehicle may each provide different levels of confidence in the resulting determination. For example, if the location obtained at 602 maps to a location that is likely not to have a vehicle (e.g., hilly hiking or biking trails), then the confidence level in the determination that the computing device 102 is not in a vehicle may be higher. If any of these techniques indicates (as determined at 606) that the location context of the computing device 102 is likely to be in a vehicle, then the process 600 proceeds to 608 to return an indicator to the process 200 (at 204) that the location context is in a vehicle. On the other hand, if none of these techniques indicates (as determined at 606) that the location context of the computing device 102 is likely to be in a vehicle, then the process 600 proceeds to 610 to return an indicator to the process 200 (at 204) that the location context is not in a vehicle.

In some embodiments, for example, the 2D location (e.g., the latitude and longitude and optionally 2D uncertainty) of the computing device 102 are mapped to a terrain, road, bridge, parking lot, or other similar database that provides the locations of roads, bridges, tunnels, parking lots, etc. in the general area of the 2D location. Thus, the 2D location and uncertainty, for example, might indicate that the computing device 102 is within a location area 142 shown in FIG. 1. A large portion of the location area 142 maps to a road, so there is a high likelihood that the computing device 102 is in a vehicle on this road, e.g., at 122. Additionally, if the road is a divided-lane highway, then the vehicle is likely to be moving relatively fast; but if the road is a residential side street, then the vehicle is likely to be moving relatively slowly. (A previous or subsequent location/time datapoint (before or after the datapoint being analyzed by the process 600) can be used to confirm the speed of the vehicle if the time difference between the two datapoints is relatively small. Additionally, other information can be used to infer the speed of the vehicle, e.g., a database of speed limits, proximity to building types such as schools or hospitals, among others.) In this case, the process 600 branches to 608 to return to the process 200 (at 204) that the location context is in a vehicle.

In some embodiments, in another example, the 2D location and uncertainty, for example, might indicate that the computing device 102 is within a location area 144 shown in FIG. 1, as determined based on the terrain, road, bridge, parking lot, or other similar database. A large portion of the location area 144 maps to a parking lot, so there is a high likelihood that the computing device 102 is in a vehicle on this parking lot, e.g., at 128. If the computing device 102 is not moving (still), then the process 600 may determine that the computing device 102 is in the vehicle while it is parked. In this case, the process 600 branches to 608 to return to the process 200 (at 204) that the location context is in a vehicle. If the computing device 102 is moving slowly (but faster than a typical walking speed), then the process 600 may determine that the computing device 102 is in the vehicle while it is driving through the parking lot. In this case, the process 600 branches to 608 to return to the process 200 (at 204) that the location context is in a vehicle. If the computing device 102 is moving at a typical walking speed, does not follow vehicle lanes of the parking lot, and/or moves in a straight line (across a winding parking lot), then the process 600 may determine that the computing device 102 is no longer in the vehicle but is now being carried by the user through the parking lot. In this case, the process 600 branches to 610 to return to the process 200 (at 204) that the location context is not in a vehicle.

In some embodiments, in another example, the 2D location and uncertainty, for example, might indicate that the computing device 102 is within the location area 136 shown in FIG. 1 (e.g., when the computing device 102 is at 130). No portion of the location area 136 maps to a road, bridge, tunnel, parking lot, etc., so there is a low likelihood that the computing device 102 is within any vehicle. In this case, the process 600 branches to 610 to return to the process 200 (at 204) that the location context is not in a vehicle.

In some embodiments, the process 600 determines or identifies that the computing device 102 is communicatively connected to a vehicle via wired or wireless means as may be indicated by an application running on the computing device 102, which indicates that the computing device 102 is within the vehicle. Thus, the process 600 determines that there is a high likelihood that the computing device 102 is inside the vehicle to which it is communicatively connected. Therefore, the process 600 branches to 608 to return to the process 200 (at 204) that the location context is in a vehicle.

In some embodiments, the process 600 determines that the computing device 102 has traversed a relatively large distance in a relatively short amount of time, i.e., the computing device 102 is moving relatively fast, which indicates that the computing device 102 is likely to be in a vehicle that is moving relatively fast, i.e., faster than a typical walking, skating, or biking speed. When this situation occurs, therefore, the process 600 branches to 608 to return to the process 200 (at 204) that the location context is in a vehicle. This option may be done if at least two datapoints are relatively close together in time.

In some embodiments, the process 600 determines that the computing device 102 is changing cell tower connections. Although this can happen when the user is travelling on foot, by bicycle, or other non-vehicle means, the speeds and distances travelled by vehicle make it more likely that a cell tower connection change is indicative of the computing device 102 being in a moving vehicle. When this situation occurs, therefore, the process 600 branches to 608 to return to the process 200 (at 204) that the location context is in a vehicle.

In some embodiments, the process 600 obtains the activity context from a sensor hub of the computing device 102. This can be done with computing devices that determine their activity context with an app that is independent from the features described herein. Typical activity contexts that such computing devices track include walking, biking, driving, and standing still, among others. Therefore, when the activity context obtained from the sensor hub is “driving” along with an activity context confidence level that is above an activity confidence threshold (e.g., about 60% or greater), then the process 600 branches to 608 to return to the process 200 (at 204) that the location context is in a vehicle. On the other hand, when the activity context obtained from the sensor hub is “walking”, “biking” or other specifically non-vehicle activity, then the process 600 branches to 610 to return to the process 200 (at 204) that the location context is not in a vehicle. Other activity contexts, such as standing still, could be ambiguous with respect to whether the computing device is in a vehicle.

In some embodiments, the process 600 determines if the location or location area of the computing device 102 maps to a nearby building (e.g., within a given threshold), but the key ratio between the device footprint and the building footprint is too small for the process 500 (FIG. 5) to determine that the computing device 102 is inside the building. In this situation, the computing device 102 might be in a parking lot outside the building, which further indicates that the computing device 102 is likely to be in a vehicle, so the process 600 branches to 608 to return to the process 200 (at 204) that the location context is in a vehicle.

In some embodiments, the process 600 performs each of the above-described techniques (among others) for determining if the computing device 102 is in a vehicle. If any one of these techniques indicates that the computing device 102 is in a vehicle, then the process 600 branches to 608 to return to the process 200 (at 204) that the location context is in a vehicle. However, if none of these techniques indicates that the computing device 102 is in a vehicle, then the process 600 branches to 610 to return to the process 200 (at 204) that the location context is not in a vehicle.

In some situations, when the computing device 102 is in a vehicle moving at a relatively high rate of speed, the environment in the vehicle is likely to be unstable with respect to air pressure due to wind turbulence. In this case, any potential HVAC effect would be difficult to disentangle or distinguish from the turbulent pressures caused by the high wind effects. Therefore, datapoints from such situations should preferably be denoted as “in vehicle, likely at high rate of speed” and flagged to not be used in any analysis for HVAC effect. U.S. Pat. No. 11,073,441, which is incorporated herein by reference as if fully set forth herein, describes such situations and metrics for the pressure variation effects thereof.

FIGS. 7-9 describe a process 700 for determining (e.g., at step 204 in FIG. 2) if it is likely that the computing device 102 is in almost any type of environment that can be subject to an HVAC effect, in accordance with some embodiments. The process 700 does this using temperature data and without determining the location context (e.g., in a building or vehicle) of the computing device 102. Instead, location context is inferred from temperature measurements and variations to be any unspecified HVAC environment (or not). Thus, if the location context of the computing device 102 (as determined by process 500 or 600) is not considered reliable or is not available, it may be possible to use the process 700 instead of or in addition to either process 500 or 600 to determine whether the computing device 102 is in an HVAC environment. The particular steps, combination of steps, and order of the steps for this process are provided for illustrative purposes only. Other processes with different steps, combinations of steps, or orders of steps can also be used to achieve the same or similar result. Features or functions described for one of the steps performed by one of the components may be enabled in a different step or component in some embodiments. Additionally, some steps may be performed before, after or overlapping other steps, in spite of the illustrated order of the steps.

At 702, the process 700 determines the temperature of the computing device 102 (device temperature) based on a measurement by a temperature sensor therein. In some embodiments, to account for heat generated by the computing device 102, the measured temperature is adjusted by an offset in order to align closer with true ambient temperature of the current environment of the computing device 102. This adjustment may be based upon device specifications, lab experimentation, or user input (e.g., subtract 10 degrees C. or 10% of the battery sensor temperature to arrive at the estimated device temperature).

At 704, the process 700 obtains a reference temperature (e.g., an outdoor temperature sourced from a network of reference sensors, a National Weather Service data feed, etc.) based on the location of the computing device 102. In some embodiments, the reference temperature may optionally be adjusted by a conventional formula using a thermal lapse rate to account for the difference between an initially determined altitude of the computing device 102 and the altitude of the reference sensor. In some embodiments, the reference temperature may be considered to be the same at both altitudes.

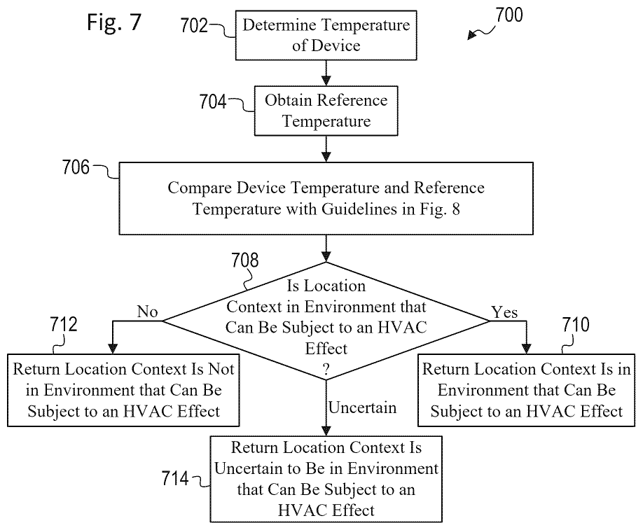

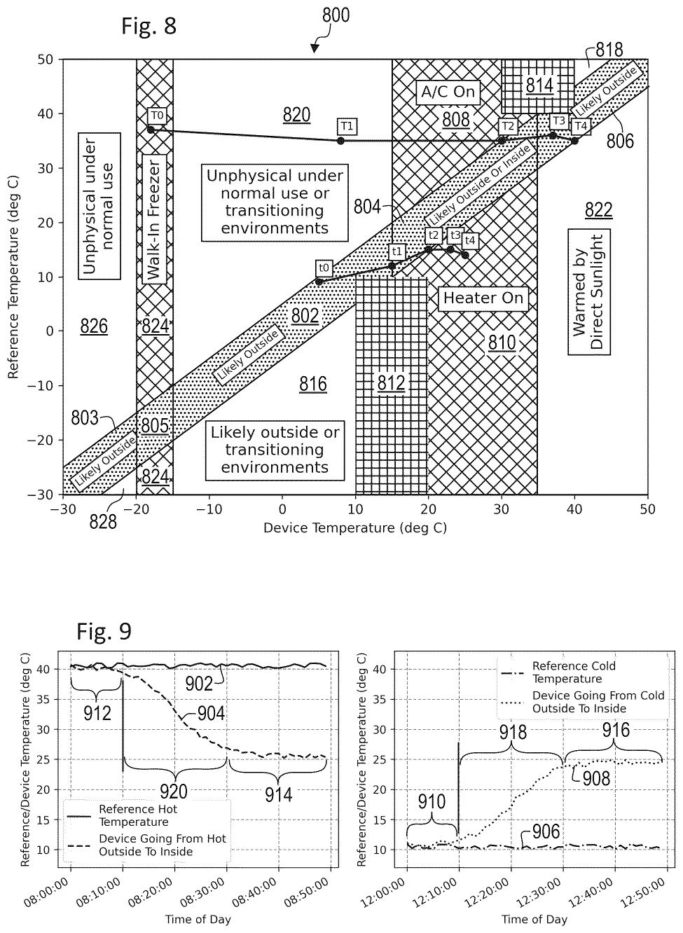

At 706, the process 700 compares the device temperature and the reference temperature based on example guidelines for techniques, tests or options illustrated by a graph 800 in FIG. 8. FIG. 8 is a simplified graph 800 of the reference temperature vs. the device temperature illustrating examples of possible or likely location contexts and changes in location contexts for use in the process 700, in accordance with some embodiments. The graph 800 includes several regions 802-828 that provide an indication of whether the computing device 102 is likely to be indoors (i.e., in an HVAC environment), outdoors (i.e., in a non-HVAC environment), or in an uncertain environment. The particular regions 802-828 and the temperature borders thereof are shown for illustrative and explanatory purposes only, because other embodiments could provide borders that are somewhat different, not include some of the regions, or include different regions that serve generally the same purpose.

Additionally, FIG. 9 shows simplified graphs 902-908 of the reference temperature (902 and 906) and the device temperature (904 and 908) vs. time of day illustrating relative differences in the reference temperature and the device temperature depending on location contexts and changes in location contexts for interpreting the data shown in FIG. 8, in accordance with some embodiments. In particular, FIG. 9 shows simulated time profiles of two devices transitioning over a period of a few minutes from outdoor environments to indoor comfortable environments, where an HVAC system could potentially affect the indoor environments. In these examples, it takes about 20 minutes for the temperature of the computing device 102 to equalize with the new indoor environment.

When the process 700 determines (at 708) that the temperature comparison at 706 (in accordance with the example guidelines of FIG. 8) indicates that the computing device 102 is likely to be in a location context that is in an environment that can be subject to an HVAC effect, then the process 700 branches to 710 to return to the process 200 (at 204) that the location context is an HVAC environment. On the other hand, when the process 700 determines (at 708) that the temperature comparison at 706 (in accordance with the example guidelines of FIG. 8) indicates that the computing device 102 is likely to be in a location context that is not in an environment that can be subject to an HVAC effect, then the process 700 branches to 712 to return to the process 200 (at 204) that the location context is a non-HVAC environment. Alternatively, when the process 700 determines (at 708) that the temperature comparison at 706 (in accordance with the example guidelines of FIG. 8) indicates that it is uncertain whether the computing device 102 is likely to be in a location context that is or is not in an environment that can be subject to an HVAC effect, then the process 700 branches to 714 to return to the process 200 (at 204) that the location context is in an uncertain environment (i.e., uncertain to be in an environment that can be subject to an HVAC effect).

Regions 802, 803, 804, 805 and 806 of the graph 800 are on a diagonal in which the reference temperature and the device temperature are about the same or within a threshold temperature range from each other, e.g., within about +/−5 degrees C. of each other. The region 802, for example, represents relatively cold temperatures for the reference temperature and the device temperature, e.g., less than an appropriate indoor “cold” threshold temperature or about 15 degrees C. (+/−5 degrees C.) and greater than a high end of a typical freezer (e.g., a walk-in freezer) temperature range (e.g., about-15 to −20 degrees C.). (The indoor cold threshold temperature is generally at a low end of a temperature range that people typically set for a comfortable indoor environment at home or work.) The reference temperature graph 906 and the device temperature graph 908 illustrate an example of this situation in portion 910 wherein these two graphs 906 and 908 are very close to each other at a relatively low temperature of about 10 degrees C. Additionally, the region 803 also represents relatively cold temperatures for the reference temperature and the device temperature that are not only less than the appropriate indoor “cold” threshold temperature but also less than a low end of the typical freezer temperature range. A situation in which both the reference temperature and the device temperature are relatively cold (but not potentially explained by being in a freezer as described below) is most likely to occur when the computing device 102 is outside any enclosed environment, i.e., in a non-HVAC environment, during cold weather long enough for the computing device 102 also to become cold. When this situation occurs, therefore, the process 700 determines (at 708) that the temperature comparison at 706 indicates that the computing device 102 is likely to be in a location context that is not in an environment that can be subject to an HVAC effect, so the process 700 branches to 712 to return to the process 200 (at 204) that the location context is a non-HVAC environment.

The region 805, on the other hand, represents an example situation that can be a potential exception to the situations represented by regions 802 and 803. For the situation of region 805, the reference temperature and the device temperature are about the same or within the threshold temperature range from each other and are less than the appropriate indoor “cold” threshold temperature (like regions 802 and 803) but are also within the typical freezer temperature range (+/−5 degrees C.) (unlike regions 802 and 803). The situation of region 805 could occur under the same circumstances as those of regions 802 and 803 or when the computing device 102 is within a freezer (e.g., when the user is working inside a walk-in freezer) and the reference temperature is also at about the same temperature range. Thus, the situation of region 805 could occur when the computing device 102 is either outside or inside. In this case, the process 700 cannot confidently determine whether the location context of the computing device 102 is in an HVAC environment. When this situation occurs, therefore, the process 700 returns (at 714) to the process 200 (at 204) that the location context is in an uncertain environment (i.e., uncertain to be in an environment that can be subject to an HVAC effect) or alternatively branches to 712 to return to the process 200 (at 204) that the location context is a non-HVAC environment (as a default result).

In another example, the region 806 illustrates another situation in which the reference temperature and the device temperature are about the same or within the threshold temperature range from each other, e.g., within about +/−5 degrees C. of each other, but within a relatively hot temperature range. The relatively hot temperature range may be, for example, greater than an appropriate indoor “hot” threshold temperature or about 35 degrees C. (+/−5 degrees C.). (The indoor hot threshold temperature is generally at a high end of a temperature range that people typically set for a comfortable indoor environment at home or work.) The reference temperature graph 902 and the device temperature graph 904 illustrate an example of this situation in portion 912 wherein these two graphs 902 and 904 are very close to each other at a relatively high temperature. A situation in which both the reference temperature and the device temperature are relatively hot is most likely to occur when the computing device 102 is outside any enclosed environment, i.e., a non-HVAC environment, during hot/warm weather long enough for the computing device 102 also to become hot/warm. When this situation occurs, therefore, the process 700 determines (at 708) that the temperature comparison at 706 indicates that the computing device 102 is likely to be in a location context that is not in an environment that can be subject to an HVAC effect, so the process 700 branches to 712 to return to the process 200 (at 204) that the location context is a non-HVAC environment.

In another example, the region 804 illustrates another situation in which the reference temperature and the device temperature are about the same or within the threshold temperature range from each other, e.g., within about +/−5 degrees C. of each other, but within a relatively comfortable temperature range for a typical user of the computing device 102. The illustrated temperature range of about 15 degrees C. to 35 degrees C. (i.e., 25 degrees C. +/−10 degrees C.) is not only a common outdoor temperature range but also a common temperature range at which indoor environments (e.g., inside homes, office buildings, etc.) are typically maintained by an HVAC system for the comfort of the people therein, i.e., the relatively comfortable temperature range is greater than the appropriate indoor “cold” threshold temperature and less than the appropriate indoor “hot” threshold temperature. Thus, a situation in which both the reference temperature and the device temperature are within a relatively comfortable temperature range could occur when the computing device 102 is either outside or inside. In this case, the location context of the computing device 102 is in an uncertain environment. When this situation occurs, therefore, the process 700 returns (at 714) to the process 200 (at 204) that the location context is in an uncertain environment (i.e., uncertain to be in an environment that can be subject to an HVAC effect) or alternatively branches to 712 to return to the process 200 (at 204) that the location context is a non-HVAC environment (as a default result).

In another example, the region 808 illustrates a situation in which the device temperature is within the relatively comfortable temperature range (e.g., about 15 degrees C. to 35 degrees C.), but the reference temperature is warmer than the device temperature, e.g., by more than the threshold temperature range. The reference temperature graph 902 and the device temperature graph 904 illustrate an example of this situation in portion 914 wherein the reference temperature graph 902 is at a relatively high temperature and the device temperature graph 904 is at a relatively mid-level temperature. In such a situation, the temperature of the computing device 102 is apparently not affected by the outdoor temperature. This situation is likely to occur when the computing device 102 is inside a temperature-controlled environment, e.g., with the air-conditioning (A/C) or cooling turned on. When this situation occurs, therefore, the process 700 branches to 710 to return to the process 200 (at 204) that the location context is an HVAC environment.

In another example, the region 810 illustrates a situation in which the device temperature is within the relatively comfortable temperature range (e.g., about 15 degrees C. to 35 degrees C.), but the reference temperature is colder than the device temperature. The reference temperature graph 906 and the device temperature graph 908 illustrate an example of this situation in portion 916 wherein the reference temperature graph 906 is at a relatively low temperature and the device temperature graph 908 is at a relatively mid-level temperature. In such a situation, the temperature of the computing device 102 is apparently not affected by the outdoor temperature. This situation is likely to occur when the computing device 102 is inside a temperature-controlled environment, e.g., with the heater turned on to maintain the relatively comfortable temperature range. When this situation occurs, therefore, the process 700 branches to 710 to return to the process 200 (at 204) that the location context is an HVAC environment.

In another example, the region 812 (shown to apparently overlap regions 802 and 810) illustrates a situation in which the reference temperature is relatively cold and the device temperature is not quite the same as the reference temperature (as for region 910) but also not quite within the relatively comfortable temperature range (as for region 916). For example, the reference temperature is below or colder than the device temperature. Also, the device temperature is 1) above the reference temperature and 2) at or near a preferred low-end temperature (e.g., the appropriate “cold” threshold temperature or about 15 C) of the comfortable temperature range within plus-or-minus an acceptable low-end temperature deviation amount (e.g., +/−5 degrees C. or 10-20 degrees C.). The reference temperature graph 906 and the device temperature graph 908 illustrate an example of this situation in portion 918 (e.g., a low-to-high transition temperature range) wherein the reference temperature graph 906 is at a relatively low temperature and the device temperature graph 908 appears to be transitioning from the relatively low temperature to the mid-level temperature. This situation is likely to occur when the computing device 102 was recently exposed to a relatively cold outdoor environment but has moved into a warmer indoor environment and is now slowly warming up to match the indoor environment. The indoor environment is, thus, likely to be an HVAC environment that is temperature-controlled with the heater turned on to maintain the relatively comfortable temperature range. When this situation occurs, therefore, the process 700 branches to 710 to return to the process 200 (at 204) that the location context is an HVAC environment. Alternatively, the process 700 branches to 714 to return to the process 200 (at 204) that the location context is in an uncertain environment (i.e., uncertain to be in an environment that can be subject to an HVAC effect), because the computing device 102 could be in an environment like that of region 816 (described below) which could be outside, in an environment like that of region 810 which could be inside, or could be transitioning between environments of regions 810 and 816. Selecting between branching to 710 or to 714 could depend on the number of datapoints or temperature measurements and their spread within region 812 and immediately outside thereof. For example, more datapoints spread out within region 812 and immediately outside the region 812 (e.g., within region 810) could result in greater certainty that the computing device 102 has transitioned from outside (region 816) to inside (region 810) and is then stabilizing to thermal equilibrium with the enclosed temperature-controlled environment of region 810.

In another example, the region 814 (shown to apparently overlap regions 806 and 808) illustrates a situation in which the reference temperature is relatively hot/warm and the device temperature is not quite the same as the reference temperature (as for region 912) but also not quite within the relatively comfortable temperature range (as for region 914). For example, the reference temperature is above or warmer than the device temperature. Also, the device temperature is 1) below the reference temperature and 2) at or near a preferred high-end temperature (e.g., the appropriate “hot” threshold temperature or about 35 C) of the comfortable temperature range plus-or-minus an acceptable high-end temperature deviation amount (e.g., +/−5 degrees C. or 30-40 degrees C.). The reference temperature graph 902 and the device temperature graph 904 illustrate an example of this situation in portion 920 (e.g., a high-to-low transition temperature range) wherein the reference temperature graph 902 is at a relatively high temperature and the device temperature graph 904 appears to be transitioning from the relatively high temperature to the mid-level temperature. This situation is likely to occur when the computing device 102 was recently exposed to a relatively hot/warm outdoor environment but has moved into a cooler indoor environment and is now slowly cooling down to match the indoor environment. The indoor environment is, thus, likely to be an HVAC environment that is temperature-controlled with the A/C cooling turned on to maintain the relatively comfortable temperature range. When this situation occurs, therefore, the process 700 branches to 710 to return to the process 200 (at 204) that the location context is an HVAC environment. Alternatively, the process 700 branches to 714 to return to the process 200 (at 204) that the location context is in an uncertain environment (i.e., uncertain to be in an environment that can be subject to an HVAC effect), because the computing device 102 could be in an environment like that of region 818 (described below) which could be outside, in an environment like that of region 808 which could be inside, or could be transitioning between environments of regions 808 and 818. Selecting between branching to 710 or to 714 could depend on the number of datapoints or temperature measurements and their spread within region 814 and immediately outside thereof. For example, more datapoints spread out within region 814 and immediately outside the region 814 (e.g., within region 808) could result in greater certainty that the computing device 102 has transitioned from outside (region 818) to inside (region 808) and is then stabilizing to thermal equilibrium with the enclosed temperature-controlled environment of region 808.

In another example, the region 816 illustrates a situation in which the reference temperature is relatively cold and the device temperature is not quite the same as the reference temperature (as for region 910) but also not clearly within the low-to-high transition temperature range (as for region 918). For example, the reference temperature is below or colder than the device temperature. Also, the device temperature is 1) above the reference temperature, 2) significantly below the preferred low-end temperature (e.g., the appropriate indoor “cold” threshold temperature or about 15 C) of the comfortable temperature range by at least the acceptable low-end temperature deviation amount (e.g., less than about 10 C, which is about 5 degrees C. below about 15 degrees C.), and 3) above the high end of the typical freezer temperature range. This situation is likely to occur 1) when the computing device 102 is outside (e.g., similar to region 802) but the computing device 102 is slightly warmed (e.g., by body heat from the user) or 2) when the computing device 102 has entered a temperature-controlled environment like that of region 810 and the temperature of the computing device 102 is transitioning from the outside cold temperature (or a walk-in freezer cold temperature) to the inside warmer temperature. When this situation occurs, therefore, the process 700 branches to 714 to return to the process 200 (at 204) that the location context is an uncertain environment.

In another example, the region 818 illustrates a situation in which the reference temperature is relatively hot/warm and the device temperature is not quite the same as the reference temperature (as for region 912) but also not clearly within the high-to-low transition temperature range (as for region 920). For example, the reference temperature is above or warmer than the device temperature. Also, the device temperature is 1) below the reference temperature and 2) significantly above the preferred high-end temperature (e.g., the appropriate “hot” threshold temperature or about 35 C) of the comfortable temperature range by at least the acceptable high-end temperature deviation amount (e.g., greater than about 40 C, which is about 5 degrees C. above about 35 degrees C.). This situation is likely to occur when the computing device 102 is 1) outside in shade (and the reference sensor providing the reference temperature is not shaded), 2) inside but being heated by the sun (e.g., next to a window), or 3) inside but recently transitioned from outside (and the device temperature has just started to transition from the hot outside temperature to the cooler inside temperature). When this situation occurs, therefore, the process 700 branches to 714 to return to the process 200 (at 204) that the location context is an uncertain environment.

In another example, the region 820 illustrates a situation in which the device temperature is cooler than (potentially a lot cooler than) the reference temperature. This situation is very unlikely to occur because it is considered to be an unphysical condition for the computing device 102 to be cooler than the ambient temperature due to the fact that there should be at least some additional heating of the computing device 102 by its own active circuitry or the user's body heat. Therefore, it is unlikely that the process 700 would ever encounter this situation and the current datapoint could be erroneous. On the other hand, the situation of region 820 could occur when the computing device 102 has been in an indoor freezer or refrigerator environment and has recently transitioned to a warmer normal temperature-controlled indoor environment like that for regions 808 or 810 or a warmer outdoor environment and the device temperature is in the process of transitioning to the warmer temperature. Alternatively, the opposite situation could have occurred in which the computing device 102 has recently transitioned to the indoor freezer or refrigerator environment. When this situation occurs, therefore, the process 700 branches to 714 to return to the process 200 (at 204) that the location context is an uncertain environment. Alternatively, if this situation were to occur, then the process 700 would return an error (not shown) to the process 200 (at 204), and the process 200 would discard the current datapoint as likely being erroneous. Determining whether to label the location context as in an uncertain environment or the current datapoint as being erroneous can depend on whether the location context for a datapoint immediately prior to the current datapoint was for a walk-in freezer or refrigerator.

In another example, the region 822 illustrates a situation in which the device temperature is warmer than (potentially a lot warmer than) the reference temperature. This situation is likely to occur when the computing device 102 is warmed by direct sunlight, which can potentially significantly increase the temperature of the computing device 102. This can occur not only when the computing device 102 is outdoors but also when it is indoors in a building or in a vehicle and sitting next to a window through which sunlight can hit it. When this situation occurs, therefore, the process 700 would return an error (not shown) to the process 200 (at 204), and the process 200 would discard the current datapoint as likely being unreliable.

In another example, the region 824 illustrates a situation in which the device temperature is within the typical freezer (e.g., a walk-in freezer) temperature range and the reference temperature is not approximately the same as the device temperature (i.e., not within the threshold temperature range from each other). This situation is likely to occur when the computing device 102 has been in a freezer environment (i.e., a type of HVAC environment) long enough to reach equilibrium with the freezer temperature. When this situation occurs, therefore, the process 700 branches to 710 to return to the process 200 (at 204) that the location context is an HVAC environment. Additionally, a similar region (not shown) could be defined for a refrigerator environment having a typical refrigerator (e.g., a walk-in refrigerator) temperature range, which would be colder than the comfortable temperature range of regions 808 and 810 but above freezing (i.e., above zero degrees C.).

In another example, the region 826 illustrates a situation in which the device temperature is cooler than (potentially a lot cooler than) the reference temperature, even cooler than the typical freezer temperature range. This situation is very unlikely to occur because it is considered to be an unphysical condition for the computing device 102 to be cooler than the ambient temperature due to the fact that there should be at least some additional heating of the computing device 102 by its own active circuitry or the user's body heat. Therefore, it is unlikely that the process 700 would ever encounter this situation. Nevertheless, if this situation were to occur, then the process 700 would return an error (not shown) to the process 200 (at 204), and the process 200 would discard the current datapoint as likely being erroneous.

In another example, the region 828 illustrates a situation in which the reference temperature is relatively cold and the device temperature is 1) slightly above the reference temperature, 2) significantly below the preferred low-end temperature of the comfortable temperature range, and 3) below the low end of the typical freezer temperature range. This situation is likely to occur when the computing device 102 is outside but the computing device 102 is slightly warmed (e.g., by body heat from the user). When this situation occurs, therefore, the process 700 branches to 710 to return to the process 200 (at 204) that the location context is a non-HVAC environment.

FIG. 8 also shows an example of five datapoints (t0-t4 with lower case “t”) for the computing device 102 moving from an outdoor environment to an indoor environment. This example illustrates a path of the computing device 102 as it is transitioning from a cold outside temperature to an indoor, comfortable temperature, potentially subject to HVAC effects. This example shows how changes in the device temperature compared with a reference temperature over a given period of time can indicate the location context of the computing device 102. The direction of the path provides confidence that the computing device 102 enters an HVAC environment at the later datapoints. The reference temperature graph 906 and the device temperature graph 908 of FIG. 9 is an example time profile for the temperature change that could occur when transitioning through the datapoints of times t0-t4.

The datapoint at time to is within the region 802, so the computing device 102 was likely to have been outside at this time, i.e., in a non-HVAC environment. The datapoint at time t1 is on the edge between the region 802 and 804, so the location context is uncertain for this time. The datapoint t2 is on the edge between the region 804 and the region 810, so again the location context is uncertain for this time. The datapoint at time t3 is within the region 810, so the location context is likely to be in a HVAC environment. The datapoint at time t4 is even further within the region 810 than the datapoint at t3 is, so the location context is even more likely to be in a HVAC environment.

The datapoints (t0, t3 and t4) that provide a likely location context, if taken in isolation from each other, would result in a possible uncertainty level or value for the location context determination. However, it is clear that the device temperature is getting warmer (as time passes from t0 to t4), while the reference temperature is staying cold. In this situation, the process 700 determines that the computing device 102 transitioned from a likely non-HVAC environment (at t0) through an uncertain environment (t1 and t2) to a likely HVAC environment (at t3 and t4). This transition provides evidence that the location context determinations for the datapoints t0, t3 and t4 may have a lower uncertainty or greater confidence level, as calculated by the process 700, because it appears to be clear that the computing device 102 is warming up (from to to t4) due to having been outside in the cold and then transitioning to inside where it was warmer. The actual point of the transition from the non-HVAC environment to the HVAC environment is likely to be at some point around time t1 or time t2. However, it is not clear exactly where the transition occurs, so the datapoints at time t1 or time t2 would be discarded by the process 200 (FIG. 2) before calculating an HVAC effect for a given environment (e.g., at 214) or determining a calibration value. If it were necessary to determine an altitude using the datapoints at time t1 or time t2, then the uncertainty in the altitude estimate would be relatively large.

Additionally, the datapoint at time to is the best data in this example for calculating a calibration value or altitude, since it is likely to be outside, so HVAC effects do not have to be taken into consideration for calibration or altitude. On the other hand, the datapoints at times t3 and t4 are highly likely to be subject to HVAC effects, so an altitude determination would take this into consideration, but a calibration would preferably not be determined unless it was necessary, e.g., the current calibration value is too stale.

FIG. 8 also shows an example of five datapoints (T0-T4 with upper case “T”) for the computing device 102 moving from a freezer environment to an outdoor environment. This example illustrates a path of the computing device 102 as it is transitioning from a cold freezer temperature (potentially subject to HVAC effects) to a warm outdoor temperature (not subject to HVAC effects). This example shows how changes in the device temperature compared with a reference temperature over a given period of time can indicate the location context of the computing device 102. The direction of the path provides confidence that the computing device 102 starts at an HVAC environment and enters a non-HVAC environment at the later datapoints.

The datapoint at time T0 is within the region 824, so the computing device 102 was likely to have been inside a freezer (e.g., a walk-in freezer) at this time, i.e., the location context is in an HVAC environment. The datapoint at time T1 is in the region 820, so the computing device 102 has likely transitioned from the freezer environment to a warmer environment and the device temperature is in the process of transitioning to the warmer temperature during this time. However, it is unknown at time T1 whether the computing device 102 has entered an indoor HVAC environment or an outdoor non-HVAC environment, so the location context is an uncertain environment at this time. The datapoint T2 is on the edge between the region 804 and the region 808, so again the location context is uncertain for this time, since the computing device 102 could be outside or inside. The datapoint at time T3 is within the region 806, which is likely outside, so the location context is likely to be in a non-HVAC environment at this time. The datapoint at time T4 is further within the region 806 but on the edge with region 822. Due to being on the edge between regions 806 and 822, the location context is an uncertain environment, or the temperature measurement data could possibly be erroneous, so the process 200 would discard the current datapoint as likely being unreliable.

The datapoints (T0 and T3) that provide a likely location context, if taken in isolation from each other, would result in a possible uncertainty level or value for the location context determination. However, it is clear that the device temperature is getting warmer (as time passes from T0 to T4), while the reference temperature is staying warm. In this situation, the process 700 determines that the computing device 102 transitioned from a likely HVAC environment (i.e., the freezer at TO) through an uncertain environment (T1 and T2) to a likely non-HVAC environment (at T3) followed by an unreliable situation (at T4). However, the context for this transition provides evidence that the location context determinations for the datapoints T1, T2 and T3 may be uncertain or unreliable, since the final destination at T4 may be considered unreliable and the intermediate datapoints T1, T2 and T3 may all have resulted when the device temperature was in the process of transitioning to the time T4. Thus, even though the datapoint at time T3 might seem in isolation to be a good measurement in a non-HVAC environment which could produce a reliable altitude determination or calibration calculation, the overall context indicates that the datapoint at time T3 is uncertain or unreliable. Given the overall context of the datapoints from T0 to T4, therefore, if it were necessary to determine an altitude using any of the datapoints, then the uncertainty in the altitude estimate would be relatively large. Additionally, it would be undesirable to use any of the datapoints for a calibration calculation.

In some embodiments, although not shown in the flowcharts for the processes 500, 600 and 700, each of these processes determines an uncertainty level or confidence level for the result of the location context being in an HVAC environment, a non-HVAC environment, or an uncertain environment.

The uncertainty or confidence can be defined, for example, as uncertainty or confidence in each of the individual techniques, tests or options described above (e.g., with respect to 504, 604 and 706/708) for each of the processes 500, 600 and 700. For example, the magnitude of the key ratio between the device footprint and the building footprint (i.e., the proportion of overlap of the device footprint with the building footprint) may be directly proportional to the confidence or indirectly proportional to the uncertainty. As another example, relative weighted confidence or uncertainty values can be empirically determined for each of the techniques, tests or options. As another example, datapoints (e.g., the datapoints at times to and t4 in FIG. 8) that are within a region of high likelihood for either indoors or outdoors and that are relatively far from an edge of the region would have a lower uncertainty or greater confidence than for those datapoints (e.g., the datapoints at times t1-t3) that are nearer to or are at a region edge.

The uncertainties or confidences resulting from the individual techniques, tests or options of the processes 500, 600 and 700 are propagated through the process 200 to contribute to the uncertainty or confidence in the calculated HVAC effect at 214 and then to that of the determined calibration value or estimated altitude at 216. In other words, a higher uncertainty in the determination of whether the computing device 102 is in an HVAC environment would result in a higher uncertainty in the calculated calibration value or altitude estimation that used the data from these points, and vice versa.

In some embodiments, a single uncertainty measurement percentage is provided for all environments (i.e., HVAC, non-HVAC, and uncertain environments). In this case, an uncertainty from 0% to about 20% (e.g., 0%≤uncertainty≤20%) is for a non-HVAC environment. Additionally, an uncertainty from about 80% to 100% (e.g., 80%≤uncertainty≤100%) is for an HVAC environment. Furthermore, an uncertainty from about 20% to about 80% (e.g., 20%<uncertainty <80%) is for an uncertain environment.

In this disclosure, the processes 500, 600 and 700 are illustrated and described separately. However, in some embodiments, the processes 500, 600 and 700 are combined into a single process that performs some or all of the options described herein to determine whether the computing device 102 is in a building, a vehicle, an unspecified HVAC environment, a non-HVAC environment, or an uncertain environment.

FIG. 10 illustrates components of an example of the reference pressure stations 106, an example of the computing devices 102, and an example of the system server 104 of the operational environment 100 shown in FIG. 1, in accordance with some embodiments. Examples of communication pathways are shown by arrows between components. The components shown in FIG. 10 are operable to perform all or a portion of the processes 200, 300, 500, 600 and 700.

By way of example in FIG. 10, each of the reference pressure stations 106 may include: a computing device interface 11 for exchanging information with the computing devices 102 (e.g., antenna(s) and RF front-end components known in the art or otherwise disclosed herein); one or more processor(s) 12; memory/data source 13 for providing storage and retrieval of information and/or program instructions; atmospheric sensor(s) 14 for measuring environmental conditions (e.g., pressure, temperature, humidity, other) at or near the reference pressure station; a server interface 15 for exchanging information with the system server 104 (e.g., an antenna, a network interface, or other); and any other components known to one of ordinary skill in the art. The memory/data source 13 may include a non-transitory memory storing software modules with executable instructions, and the processor(s) 12 may perform different actions by executing the instructions from the modules, including (i) performance of a part or all of the methods or processes as described herein or otherwise understood by one of skill in the art as being performable at the reference pressure station; (ii) generation of positioning signals for transmission using a selected time, frequency, code, and/or phase; (iii) processing of signals received from the computing device or another source; or (iv) other processing as required by operations described in this disclosure. Signals generated and transmitted by a reference pressure station may carry different information that, once determined by a computing device or a server, may identify the following: the reference pressure station; the reference pressure station's position; environmental conditions at or near the reference pressure station; and/or other information known in the art. The atmospheric sensor(s) 14 may be integral with the reference pressure station, or separate from the reference pressure station and either co-located with the reference pressure station or located in the vicinity of the reference pressure station (e.g., within a threshold amount of distance).

By way of example in FIG. 10, the computing device 102 may include: a reference pressure station interface 21 for exchanging information with a reference pressure station (e.g., an antenna and RF front-end components known in the art or otherwise disclosed herein); one or more processor(s) 22; memory/data source 23 for providing storage and retrieval of information and/or program instructions; atmospheric sensor(s) 24 (such as barometers and temperature sensors) for measuring environmental conditions (e.g., pressure, temperature, other) at the computing device; other sensor(s) 25 for measuring other conditions (e.g., inertial sensors for measuring movement and orientation); a user interface 26 (e.g., display, keyboard, microphone, speaker, other) for permitting a user to provide inputs and receive outputs; a network interface 27 for exchanging information with the system server 104 or other devices external to the computing device (e.g., an antenna, a network interface, or other); and any other components known to one of ordinary skill in the art. A GNSS interface and processing unit (not shown) are contemplated, which may be integrated with other components (e.g., the interface 21 and the processors 22) or a standalone antenna, RF front end, and processors dedicated to receiving and processing GNSS signaling. The memory/data source 23 may include a non-transitory memory (e.g., a data storage module) storing software modules with executable instructions, and the processor(s) 22 may perform different actions by executing the instructions from the modules, including (i) performance of a part or all of the methods as described herein or otherwise understood by one of ordinary skill in the art as being performable at the computing device; (ii) estimation of an altitude of the computing device based on measurements of pressure from the computing device and reference pressure station(s), temperature measurement(s) from the reference pressure station(s) or another source, and any other information needed for the computation; (iii) processing of received signals to determine position information (e.g., times of arrival or travel time of the signals, pseudoranges between the computing device and reference pressure stations, reference pressure station atmospheric conditions, reference pressure station and/or locations or other reference pressure station information); (iv) use of position information to compute an estimated position of the computing device; (v) determination of movement based on measurements from inertial sensors of the computing device; (vi) GNSS signal processing; (vii) determination of location context; (viii) determination of HVAC effect; or (ix) other processing as required by operations described in this disclosure.

By way of example in FIG. 10, the system server 104 may include: a computing device interface 31 for exchanging information with a computing device (e.g., an antenna, a network interface, or other); one or more processor(s) 32; memory/data source 33 for providing storage and retrieval of information and/or program instructions; a reference pressure station interface 34 for exchanging information with a reference pressure station (e.g., an antenna, a network interface, or other); and any other components known to one of ordinary skill in the art. The memory/data source 33 may include a non-transitory memory storing software modules with executable instructions, and the processor(s) 32 may perform different actions by executing instructions from the modules, including (i) performance of a part or all of the methods as described herein or otherwise understood by one of ordinary skill in the art as being performable at the server; (ii) estimation of an altitude of the computing device; (iii) computation of an estimated position of the computing device; (iv) determination of location context; (v) determination of HVAC effect; or (vi) other processing as required by operations described in this disclosure. Steps performed by servers as described herein may also be performed on other machines that are remote from a computing device, including computers of enterprises or any other suitable machine.

Certain aspects disclosed herein relate to estimating the positions of computing devices—e.g., where the position is represented in terms of latitude, longitude, and/or altitude coordinates; x, y, and/or z coordinates; angular coordinates; or other representations. Various techniques to estimate the position of a computing device can be used, including trilateration, which is the process of using geometry to estimate the position of a computing device using distances traveled by different “positioning” (or “ranging”) signals that are received by the computing device from different beacons (e.g., terrestrial transmitters and/or satellites). If position information like the transmission time and reception time of a positioning signal from a beacon is known, then the difference between those times multiplied by the speed of light would provide an estimate of the distance traveled by that positioning signal from that beacon to the computing device. Different estimated distances corresponding to different positioning signals from different beacons can be used along with position information like the locations of those beacons to estimate the position of the computing device. Positioning systems and methods that estimate a position of a computing device (in terms of latitude, longitude, and/or altitude) based on positioning signals from beacons (e.g., transmitters, and/or satellites) and/or atmospheric measurements are described in co-assigned U.S. Pat. No. 8,130,141, issued Mar. 6, 2012, and U.S. Pat. No. 9,057,606, issued Jun. 16, 2015, incorporated by reference herein in their entirety for all purposes. It is noted that the term “positioning system” may refer to satellite systems (e.g., Global Navigation Satellite Systems (GNSS) like GPS, GLONASS, Galileo, and Compass/Beidou), terrestrial transmitter systems, and hybrid satellite/terrestrial systems.

Reference has been made in detail to embodiments of the disclosed invention, one or more examples of which have been illustrated in the accompanying figures. Each example has been provided by way of an explanation of the present technology, not as a limitation of the present technology. In fact, while the specification has been described in detail with respect to specific embodiments of the invention, it will be appreciated that those skilled in the art, upon attaining an understanding of the foregoing, may readily conceive of alterations to, variations of, and equivalents to these embodiments. For instance, features illustrated or described as part of one embodiment may be used with another embodiment to yield a still further embodiment. Thus, it is intended that the present subject matter covers all such modifications and variations within the scope of the appended claims and their equivalents. These and other modifications and variations to the present invention may be practiced by those of ordinary skill in the art, without departing from the scope of the present invention, which is more particularly set forth in the appended claims. Furthermore, those of ordinary skill in the art will appreciate that the foregoing description is by way of example only, and is not intended to limit the invention.

What is claimed is:

1. A method comprising:
determining a location of a computing device;
determining a location context for the computing device, wherein the location context indicates whether the computing device is in an HVAC (heating, ventilating, or air-conditioning) environment that can be subject to an HVAC effect or is in a non-HVAC environment that is not subject to the HVAC effect;
upon determining that the computing device is in the non-HVAC environment, not determining the HVAC effect; and
upon determining that the computing device is in the HVAC environment:
obtaining an expected altitude of the computing device based on the location of the computing device;
determining a measured altitude of the computing device based on a reference pressure and a measured pressure from a pressure sensor of the computing device;
determining an altitude difference between the expected altitude and the measured altitude;
determining the HVAC effect based on the altitude difference; and
calibrating the pressure sensor based on the HVAC effect or estimating a corrected measured altitude of the computing device based on the HVAC effect.

2. The method of claim 1, wherein determining the location context for the computing device further comprises:
determining a device temperature of the computing device;
obtaining a reference temperature based on the location of the computing device; and
determining the location context by comparing the device temperature and the reference temperature.

3. The method of claim 2, wherein determining the location context for the computing device further comprises:
determining that the reference temperature and the device temperature are within a threshold temperature range from each other;
determining that the reference temperature and the device temperature are both less than a cold threshold temperature; and
determining that the computing device is in the non-HVAC environment.

4. The method of claim 2, wherein determining the location context for the computing device further comprises:
determining that the reference temperature and the device temperature are within a threshold temperature range from each other;
determining that the reference temperature and the device temperature are both greater than a hot threshold temperature; and
determining that the computing device is in the non-HVAC environment.

5. The method of claim 2, wherein:
the location context further indicates whether the computing device is in the HVAC environment, the non-HVAC environment, or an uncertain environment; and
determining the location context for the computing device further comprises:
determining that the reference temperature and the device temperature are within a threshold temperature range from each other;
determining that the reference temperature and the device temperature are both greater than a cold threshold temperature and less than a hot threshold temperature; and
determining that the computing device is in the uncertain environment.

6. The method of claim 2, wherein determining the location context for the computing device further comprises:
determining that the reference temperature is warmer than the device temperature;
determining that the device temperature is greater than a cold threshold temperature and less than a hot threshold temperature; and
determining that the computing device is in the HVAC environment.

7. The method of claim 2, wherein determining the location context for the computing device further comprises:
determining that the reference temperature is colder than the device temperature;
determining that the device temperature is greater than a cold threshold temperature and less than a hot threshold temperature; and
determining that the computing device is in the HVAC environment.

8. The method of claim 2, wherein:
the location context further indicates whether the computing device is in the HVAC environment, the non-HVAC environment, or an uncertain environment; and
determining the location context for the computing device further comprises:
determining that the reference temperature is colder than the device temperature;
determining that the device temperature is near a cold threshold temperature within a low-end temperature deviation amount; and
determining that the computing device is in the HVAC environment or the uncertain environment.

9. The method of claim 2, wherein:
the location context further indicates whether the computing device is in the HVAC environment, the non-HVAC environment, or an uncertain environment; and
determining the location context for the computing device further comprises:
determining that the reference temperature is warmer than the device temperature;
determining that the device temperature is near a hot threshold temperature within a high-end temperature deviation amount; and
determining that the computing device is in the HVAC environment or the uncertain environment.

10. The method of claim 2, wherein determining the location context for the computing device further comprises:
determining that the reference temperature is colder than the device temperature;
determining that the device temperature is below a cold threshold temperature; and
determining that the computing device is in the non-HVAC environment.

11. The method of claim 2, wherein:
the location context further indicates whether the computing device is in the HVAC environment, the non-HVAC environment, or an uncertain environment; and
determining the location context for the computing device further comprises:
determining that the reference temperature is warmer than the device temperature;
determining that the device temperature is above a hot threshold temperature; and
determining that the computing device is in the uncertain environment.

12. The method of claim 2, wherein determining the location context for the computing device further comprises:
determining the location context by comparing the device temperature and the reference temperature and further determining how the device temperature changes over time.

13. The method of claim 1, wherein:
the steps from the determining of the location of the computing device to the determining of the altitude difference are repeated for each time point of a plurality of time points; and
the determining of the HVAC effect further comprises:
for each time point of the plurality of time points, mapping the altitude difference with respect to the location context to generate mapped altitude differences;
determining a first cluster of the mapped altitude differences for when the computing device is in the HVAC environment;
determining a second cluster of the mapped altitude differences for when the computing device is in the non-HVAC environment; and
determining the HVAC effect based on the first cluster of the mapped altitude differences and the second cluster of the mapped altitude differences.

14. The method of claim 13, wherein the determining of the HVAC effect further comprises:
for each time point of the plurality of time points, mapping the altitude difference with respect to the time point and the location context to generate the mapped altitude differences.

15. The method of claim 13, wherein the determining of the HVAC effect further comprises:
determining a magnitude of the HVAC effect that is a difference between a first average of the first cluster of the mapped altitude differences and a second average of the second cluster of the mapped altitude differences.

16. The method of claim 1, wherein determining the location context for the computing device further comprises:
determining that the location context is in the HVAC environment which is a building.

17. The method of claim 16, wherein determining the location context for the computing device further comprises:
determining that the computing device is in the building by mapping the location of the computing device to a building database, which indicates that the computing device is within the building;
determining that the computing device is in the building by determining that the computing device is wirelessly connected to a wireless access point that is known to be in the building, which indicates that the computing device is within the building; or
determining that the computing device is in the building by determining that a strength of a satellite signal is attenuated from a level that it should be if the computing device were outdoors, which indicates that the computing device is within the building.

18. The method of claim 1, wherein determining the location context for the computing device further comprises:
determining that the location context is in the HVAC environment which is a vehicle.

19. The method of claim 18, wherein determining the location context for the computing device further comprises:
determining that the computing device is in the vehicle by mapping the location of the computing device to a road database, which indicates that the computing device is on a road and within the vehicle;
determining that the computing device is in the vehicle by determining that the computing device is communicatively connected to the vehicle, which indicates that the computing device is within the vehicle;
determining that the computing device is in the vehicle by determining that the computing device is moving faster than a walking, running or biking speed, which indicates that the computing device is within the vehicle;
determining that the computing device is in the vehicle by determining that the computing device is changing cell tower connections, which indicates that the computing device is within the vehicle;
determining that the computing device is in the vehicle by obtaining an activity context from a sensor hub of the computing device that indicates that the activity context is driving, which indicates that the computing device is within the vehicle;
determining that the computing device is in the vehicle by determining that the computing device is in a parking lot, which indicates that the computing device is within the vehicle; or
determining that the computing device is not in the vehicle by determining that the computing device is in the parking lot and is moving at a walking speed, does not follow vehicle lanes of the parking lot, or moves in a straight line.

20. A method comprising:
determining a location of a computing device;
determining a location context for the computing device, wherein the location context indicates whether the computing device is in an HVAC (heating, ventilating, or air-conditioning) environment that can be subject to an HVAC effect or is in a non-HVAC environment that is not subject to the HVAC effect;
upon determining that the computing device is in the non-HVAC environment, not determining the HVAC effect; and
upon determining that the computing device is in the HVAC environment:
determining a first measured pressure from the computing device using a pressure sensor of the computing device when the computing device is in the non-HVAC environment and a second measured pressure from the computing device using the pressure sensor when the computing device is in the HVAC environment;
determining a pressure difference between the first measured pressure and the second measured pressure;
determining the HVAC effect based on the pressure difference; and
calibrating the pressure sensor based on the HVAC effect or estimating a measured altitude of the computing device based on the HVAC effect.
